(19) United States
(12) Patent Application Publication
(10) Pub. No.: US 2019/0295101 A1
(43) Pub. Date: Sep. 26, 2019

(54) DIGITAL CREDENTIAL RECEIVER FIELD MAPPINGS

(71) Applicant: Pearson Education, Inc., New York, NY (US)

(72) Inventors: Clarke Porter, Minneapolis, MN (US); Kirk Becker, Chicago, IL (US)

(21) Appl. No.: 15/928,529

(22) Filed: Mar. 22, 2018

(51) Int. Cl. G06Q 30/00; G06F 17/30

(52) U.S. Cl. CPC G06Q 30/018; G06F 17/30371; G06F 17/30377

(57) ABSTRACT

Techniques described herein relate to receiving multiple sources of verified data associated with a digital credential receiver, and mapping the digital credential receiver to one or more data field data objects based on analyses of the verified data. In some embodiments, a digital credential platform server may analyze the various data sources associated with the digital credential receiver, in order to determine and calculate correlation scores between the digital credential receiver and various field data objects. A combination of analyses and/or comparisons may be used between the credential receiver data and the corresponding retrieved from field data objects, such as the digital credential objects earned by the credential receiver, the credential receiver's verified evaluation records, and/or the career phase of the digital credential receiver.

### BACKGROUND

Changes in computing technologies have provided individuals with additional options for obtaining and validating technical skills and proficiencies. Rather than attending traditional educational institutions and professional training courses, many individuals may now obtain their technical skills and proficiencies from alternative sources, such as structured or unstructured and asynchronous eLearning programs using distance learning technology, self-study research without any direct supervision, or various alternative technical learning, training, and testing entities. Although such advances in technologies and increasing globalization trends provide many more options for individuals to obtain technical skills and proficiencies, they also present challenges in publishing, verifying, and tracking the sets of technical skills and proficiencies that these individuals have obtained. Many individuals and institutions no longer rely on physical certificates such as diplomas, transcripts, certification statements, and physical licenses, to verify the authenticity of an individual's proficiencies or qualifications. Instead, certain institutions may issue digital credentials (or digital badges) to qualifying individuals, and these digital credential earners may use the digital credentials to certify the skills or qualifications that the earner obtained vis-à-vis the institution.

### BRIEF SUMMARY

Various techniques are described herein for receiving multiple sources of verified data associated with a digital credential receiver, and mapping the digital credential receiver to one or more data field data objects based on analyses of the verified data. In various embodiments, a digital credential platform server may receive requests from client devices identifying a digital credential receiver. In response to such requests, the digital credential platform server may retrieve data corresponding to a set of digital credential objects received by the digital credential receiver. The digital credential platform server also may retrieve one or more verified evaluation records, for example, from a secure third-party provider server, associated with the digital credential receiver. Verified evaluation records may include, for instance, results of personality or interest evaluations administered to the digital credential receiver, results of automated evaluations of the receiver's digital records of interactions, and the like, in order to further assess compatibility of the digital credential receiver with particular fields. Additionally, in some embodiments, the digital credential platform server may retrieve and/or determine a career phase associated with the digital credential receiver, which may be relevant to the mapping analysis.

Additional techniques are described herein in which the digital credential platform server may analyze the various data sources associated with the digital credential receiver, in order to determine and calculate correlation scores between the digital credential receiver and various field data objects. In some embodiments, the digital credential platform server may use a combination of analyses and/or comparisons between the receiver data and related data retrieved from a plurality of different field data objects. For example, the digital credential objects (or digital badges) earned by the receiver may be compared to the corresponding capabilities, skills, certifications, etc., associated with different fields in a field data structure. Additionally, the receiver's verified evaluation records may be compared to the corresponding interest or personality data associated with the different fields. Further, in some cases, the current career phase of the digital credential receiver may be compared to corresponding career phase data associated with the different fields. Based on the various combination of analyses and comparisons, the platform server may calculate correlation scores for a plurality of different field data objects, and designate/transmit a subset of the fields that correlate most closely to the digital credential receiver.

Various additional techniques described herein relate to both the retrieval of different types of credential receiver data and/or field data from different data sources, and/or to the analyses and correlation calculations between digital credential receivers and field data objects. For example, in some embodiments, the platform server may store and maintain expiration dates and/or half-lives for various types of data associated with digital credential receivers, such as the receiver's digital credentials, the receiver's verified evaluation data, and the receiver's career phase data. Expiration dates and/or half-lives may be used as a multiplier to weight the correlation calculations of credential receivers to field data objects. Additionally, in some embodiments, reverse analyses and calculations may be performed, in which a plurality of different digital credential receivers are selected and scored based on their correlation to a particular field data object representing an occupation or an individual job listing. Additionally, various embodiments described herein may include digital credentials issued to receivers based on the detection of specific interests and/or personality traits within the users, specific DNA traits and/or health-based traits, and/or for various other types or combinations of traits that may be detected for particular digital credential receivers, and these digital credentials may further be used in the correlation analyses. Still other aspects described herein may relate to a secure digital certification platform and/or service, to provide digital credential certification, verification, and security, in order to address problems associated with anonymous and/or unverified digital credentials and/or credential receivers.

### BRIEF DESCRIPTION OF THE DRAWINGS

FIG. 1 is a block diagram showing illustrating an example of a content distribution network.

FIG. 2 is a block diagram illustrating a computer server and computing environment within a content distribution network.

FIG. 3 is a block diagram illustrating an embodiment of one or more data store servers within a content distribution network.

FIG. 4 is a block diagram illustrating an embodiment of one or more content management servers within a content distribution network.

FIG. 5 is a block diagram illustrating the physical and logical components of a special-purpose computer device within a content distribution network.

FIG. 6 is a block diagram illustrating an example system for generating, managing, and tracking digital credential templates and digital credentials, according to one or more embodiments of the disclosure.

FIG. 7 is another block diagram illustrating an example system for analyzing and mapping digital credential receivers to field data objects, according to one or more embodiments of the disclosure.

FIG. 8 is a flow diagram illustrating an example process of analyzing and correlating digital credential receivers to field data objects, according to one or more embodiments of the disclosure.

FIG. 9 is an example user interface screen generated by a digital credential platform server to display an issued digital credential, according to one or more embodiments of the disclosure.

FIG. 10 is an example user interface screen displaying a field/occupation document, according to one or more embodiments of the disclosure.

FIG. 11 is an example user interface screen generated by a digital credential platform server to display a credential receiver view illustrating various features available to authorized badge earners, according to one or more embodiments of the disclosure.

FIG. 12 is another block diagram illustrating an example system for analyzing and mapping digital credential receivers to field data objects, including an interest/trait digital credential issuer tool, according to one or more embodiments of the disclosure.

FIG. 13 is a flow diagram illustrating an example process of issuing and storing digital credentials based on interest, trait, and/or personality data, according to one or more embodiments of the disclosure.

FIG. 14 is another block diagram illustrating an example system for analyzing and mapping digital credential receivers to field data objects, including a digital credential certification service, according to one or more embodiments of the disclosure.

FIG. 15 is a flow diagram illustrating an example process for certifying and registering digital credentials within a digital credential platform, and verifying the capabilities/skills associated with a digital credential, according to one or more embodiments of the disclosure.

In the appended figures, similar components and/or features may have the same reference label. Further, various compo of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Various techniques (e.g., systems, methods, computer-program products tangibly embodied in a non-transitory machine-readable storage medium, etc.) are described herein for receiving multiple sources of verified data associated with a digital credential receiver (e.g., a digital badge earner), and mapping the receiver to one or more data field data objects (e.g., occupations/fields in an ONET database or other occupation data store) based on analyses of the verified data. In various embodiments, a digital credential platform server or other computing device may receive requests from client devices identifying a digital credential receiver. In response to such requests, the platform server may retrieve various data associated with the digital credential receiver, such as a corresponding set of digital credential objects (or digital badges) earned by the receiver, one or more verified evaluation records (e.g., from a secure third-party server), and/or a career stage or phase associated with the digital credential receiver. As noted above, verified evaluation records for a digital badge earner may include, for instance, results of personality or interest evaluations administered to the digital credential receiver, results of automated evaluations of the receiver's digital records of interactions, etc., which may be used to further assess compatibility of the digital credential receiver with particular fields. In some cases, such evaluation records may be accessible to and/or modifiable by the receiver via the digital credential platform server, while in other cases the platform server may be configured to store securely and expressly prohibit receivers from accessing their associated verified evaluation records.

Additional techniques are described herein in which the platform server analyzes the various data sources associated with the digital badge earner, in order to determine and calculate correlation scores between the badge earner and various fields/occupations. As used herein, the correlation between a particular individual (e.g., a badge earner/credential receiver) and a particular occupation/field/job description may refer to the degree to which the individual and occupation are determined to be suitable match or fit for one another. As discussed below, the generation of a correlation score by a platform server may be a measurement based on multiple different matching determinations, including the matching of skills demonstrated by the particular badge earner against the skills required for the occupation, the matching of the personality traits of the particular badge earner against the personality traits associated with the occupation (e.g., traits of highest performing workers in that occupation, traits of satisfied workers in that occupation, etc.), and/or the matching of the current career stage of the particular badge earner against the career stage associated with the occupation, among other matching measurements and determinations as described herein. In some embodiments, the platform server may use a combination of analyses and/or comparisons between the badge earner data and the corresponding data associated with different field data objects. For example, the digital credential objects/badges earned by the receiver may be compared to the corresponding capabilities, skills, certifications, etc., associated with different fields/occupations in a field/occupation data structure. Additionally, the receiver's verified evaluation records may be compared to the corresponding interest or personality data associated with the different occupations/fields. In some embodiments, the current career phase of the credential receiver/badge earner may be compared to corresponding career phase data associated with the different occupations/fields. Based on the various combination of analyses and comparisons, the platform server may calculate correlation scores for a plurality of different fields, occupations, and/or job listings, and may designate and transmit a subset of the fields/occupations/jobs that correlate most closely to the badge earner.

Various additional techniques described herein relate to both the retrieval of different types of digital badge earner data and/or field/occupation data from different data sources, and/or to the analyses and correlation calculations between digital badge earners and fields/occupations. For example, in some embodiments, the platform server may store and maintain expiration dates and/or half-lives for various types of data associated with credential receivers/badge earners, such as the individual digital credentials or combinations of credentials, verified evaluation data of the badge earner, and current career stage/phase of the badge earner. Expiration dates and/or half-lives may be used as a multiplier to weight the correlation calculations of badge earners to field/occupations. Additionally, in some embodiments, reverse processes for analyzing and calculating correlations may be performed, for example, whereby a plurality of different badge earners (e.g., candidates or job seekers) are selected and scored based on their level of correlation to a particular fields, occupations, and/or individual job listings. Additionally, embodiments described herein may include digital credentials/badges issued to badge earners/receivers based on the detection of specific interests and/or personality traits within the badge earners, specific DNA traits and/or health-based traits, and/or for various other types or combinations of traits that may be detected for particular badge earners. These different types of digital credentials/badges may be incorporated into any correlation analyses described herein. Still other techniques described herein may relate to a secure digital certification platform and/or service, to provide digital credential certification, verification, and security, in order to address problems associated with anonymous and/or unverified digital credentials and/or credential receivers.

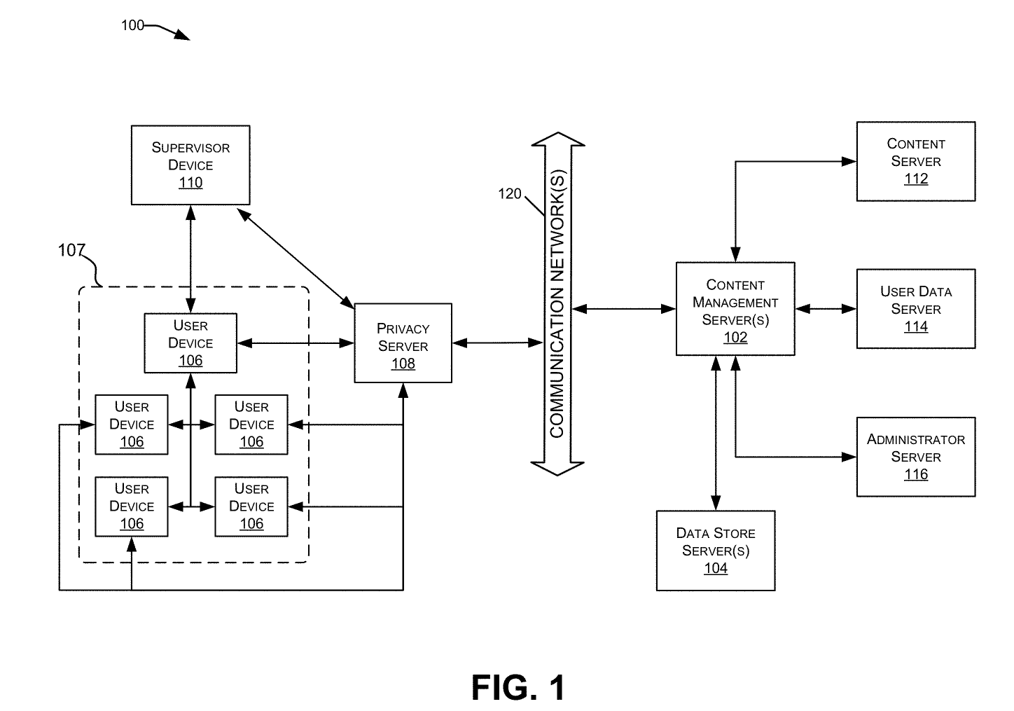

With reference now to FIG. 1, a block diagram is shown illustrating various components of a content distribution network (CDN) 100 which implements and supports certain embodiments and features described herein. Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Content management server 102 may include one or more server farms, clusters, or any other appropriate arrangement and/or combination or computer servers. Content management server 102 may act according to stored instructions located in a memory subsystem of the server 102, and may run an operating system, including any commercially available server operating system and/or any other operating systems discussed herein.

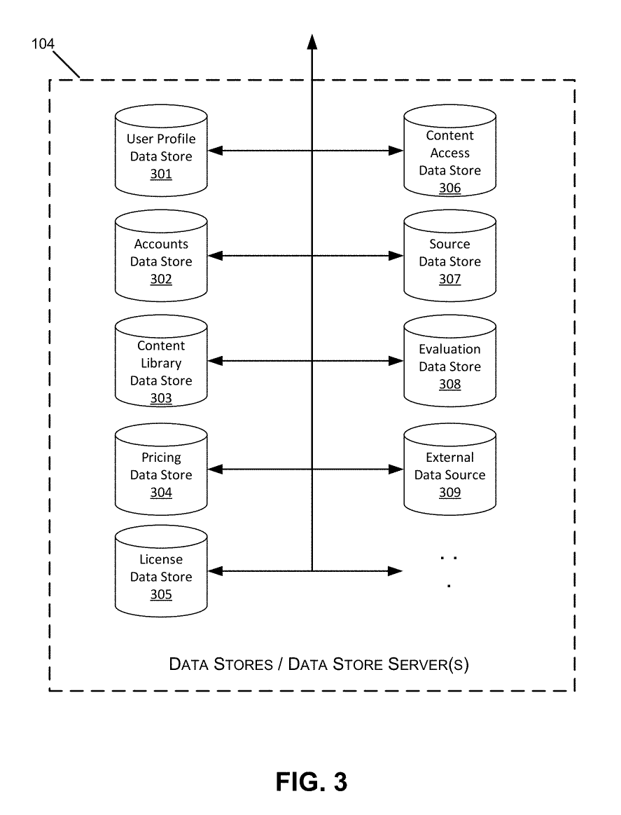

The content distribution network 100 may include one or more data store servers 104, such as database servers and file-based storage systems. Data stores 104 may comprise stored data relevant to the functions of the content distribution network 100. Illustrative examples of data stores 104 that may be maintained in certain embodiments of the content distribution network 100 are described below in reference to FIG. 3. In some embodiments, multiple data stores may reside on a single server 104, either using the same storage components of server 104 or using different physical storage components to assure data security and integrity between data stores. In other embodiments, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as thin-client computers, Internet-enabled gaming systems, business or home appliances, and/or personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated SSL and HTTPS, WS-Security, firewalls, etc.) to communicate with the content management server 102 and/or other remotely located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including their user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

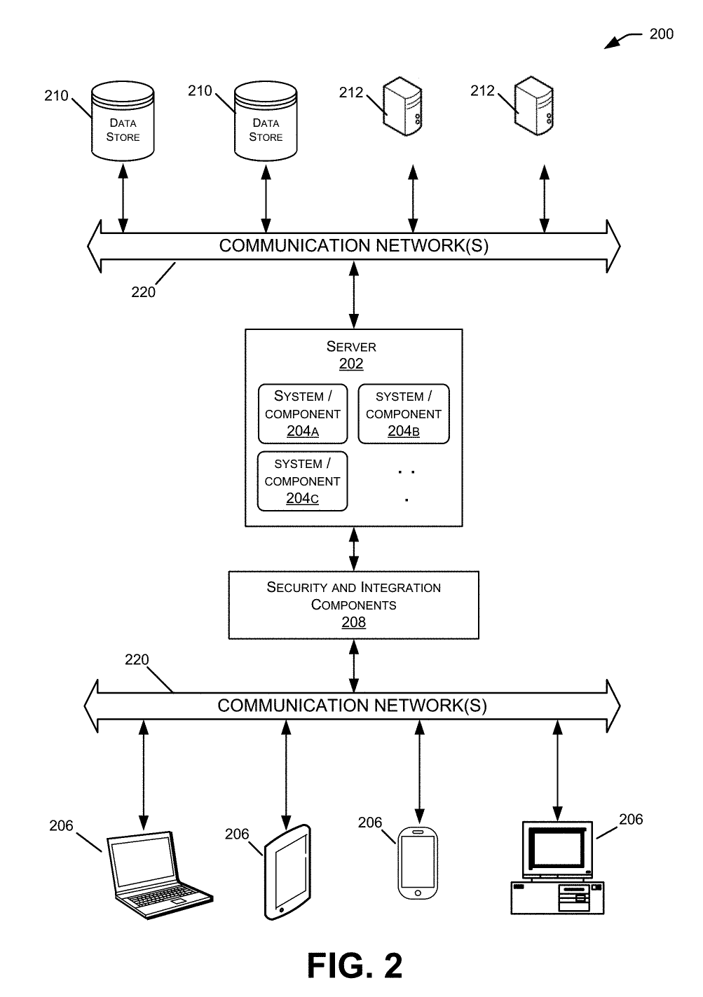

With reference to FIG. 2, an illustrative distributed computing environment 200 is shown including a computer server 202, four client computing devices 206, and other components that may implement certain embodiments and features described herein. In some embodiments, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to transmit, receive, and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 220 may be local area networks (LAN), such as one based on Ethernet, Token-Ring and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 220.

Computing environment 200 also may include one or more data stores 210 and/or back-end servers 212. In certain examples, the data stores 210 may correspond to data store server(s) 104 discussed above in FIG. 1, and back-end servers 212 may correspond to the various back-end servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a storage-area network (SAN), or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-309 may reside in storage on a single computer server 104 (or a single server farm or cluster) under the control of a single entity, or may reside on separate servers operated by different entities and/or at remote locations. In some embodiments, data stores 301-309 may be accessed by the content management server 102 and/or other devices and servers within the network 100 (e.g., user devices 106, supervisor devices 110, administrator servers 116, etc.). Access to one or more of the data stores 301-309 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-309, including their functionality and types of data stored therein, are illustrative and non-limiting. Data stores server architecture, design, and the execution of specific data stores 301-309 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301 may include information relating to the end users within the content distribution network 100. This information may include user characteristics such as the user names, access credentials (e.g., login and passwords), user preferences, and information relating to any previous user interactions within the content distribution network 100 (e.g., requested content, posted content, content modules completed, training scores or evaluations, other associated users, etc.).

An accounts data store 302 may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303 may include information describing the individual content items (or content resources) available via the content distribution network 100. In some embodiments, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage and. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network 100. In some embodiments, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

In addition to the illustrative data stores described above, data store server(s) 104 (e.g., database servers, file-based storage servers, etc.) may include one or more external data aggregators 309. External data aggregators 309 may include third-party data sources accessible to the content management network 100, but not maintained by the content management network 100. External data aggregators 309 may include any electronic information source relating to the users, content resources, or applications of the content distribution network 100. For example, external data aggregators 309 may be third-party data stores containing demographic data, education related data, consumer sales data, health related data, and the like. Illustrative external data aggregators 309 may include, for example, social networking web servers, public records data stores, learning management systems, educational institution servers, business servers, consumer sales data stores, medical record data stores, etc. Data retrieved from various external data aggregators 309 may be used to verify and update user account information, suggest user content, and perform user and content evaluations.

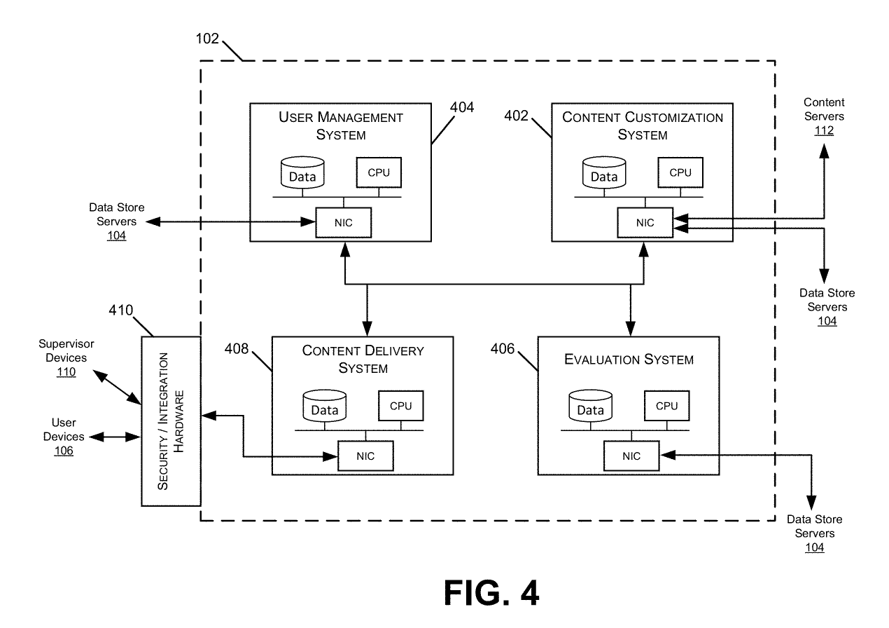

With reference now to FIG. 4, a block diagram is shown illustrating an embodiment of one or more content management servers 102 within a content distribution network 100. As discussed above, content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a content customization system 402. The content customization system 402 may be implemented using dedicated hardware within the content distribution network 100 (e.g., a content customization server 402), or using designated hardware and software resources within a shared content management server 102. In some embodiments, the content customization system 402 may adjust the selection and adaptive capabilities of content resources to match the needs and desires of the users receiving the content. For example, the content customization system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the content customization system 402 may modify content resources for individual users.

A content management server 102 also may include a user management system 404. The user management system 404 may be implemented using dedicated hardware within the content distribution network 100 (e.g., a user management server 404), or using designated hardware and software resources within a shared content management server 102. In some embodiments, the user management system 404 may monitor the progress of users through various types of content resources and groups, such as media compilations, courses or curriculums in training or educational contexts, interactive gaming environments, and the like. For example, the user management system 404 may query one or more databases and/or data store servers 104 to retrieve user data such as associated content compilations or programs, content completion status, user goals, results, and the like.

A content management server 102 also may include an evaluation system 406. The evaluation system 406 may be implemented using dedicated hardware within the content distribution network 100 (e.g., an evaluation server 406), or using designated hardware and software resources within a shared content management server 102. The evaluation system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some embodiments, the evaluation server 406 may analyze the information to determine the effectiveness or appropriateness of content resources with, for example, a subject matter, an age group, a skill level, or the like. In some embodiments, the evaluation system 406 may provide updates to the content customization system 402 or the user management system 404, with the attributes of one or more content resources or groups of resources within the network 100. The evaluation system 406 also may receive and analyze user evaluation data from user devices 106, supervisor devices 110, and administrator servers 116, etc. For instance, evaluation system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

A content management server 102 also may include a content delivery system 408. The content delivery system 408 may be implemented using dedicated hardware within the content distribution network 100 (e.g., a content delivery server 408), or using designated hardware and software resources within a shared content management server 102. The content delivery system 408 may receive content resources from the content customization system 402 and/or from the user management system 404, and provide the resources to user devices 106. The content delivery system 408 may determine the appropriate presentation format for the content resources based on the user characteristics and preferences, and/or the device capabilities of user devices 106. If needed, the content delivery system 408 may convert the content resources to the appropriate presentation format and/or compress the content before transmission. In some embodiments, the content delivery system 408 may also determine the appropriate transmission media and communication protocols for transmission of the content resources.

In some embodiments, the content delivery system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

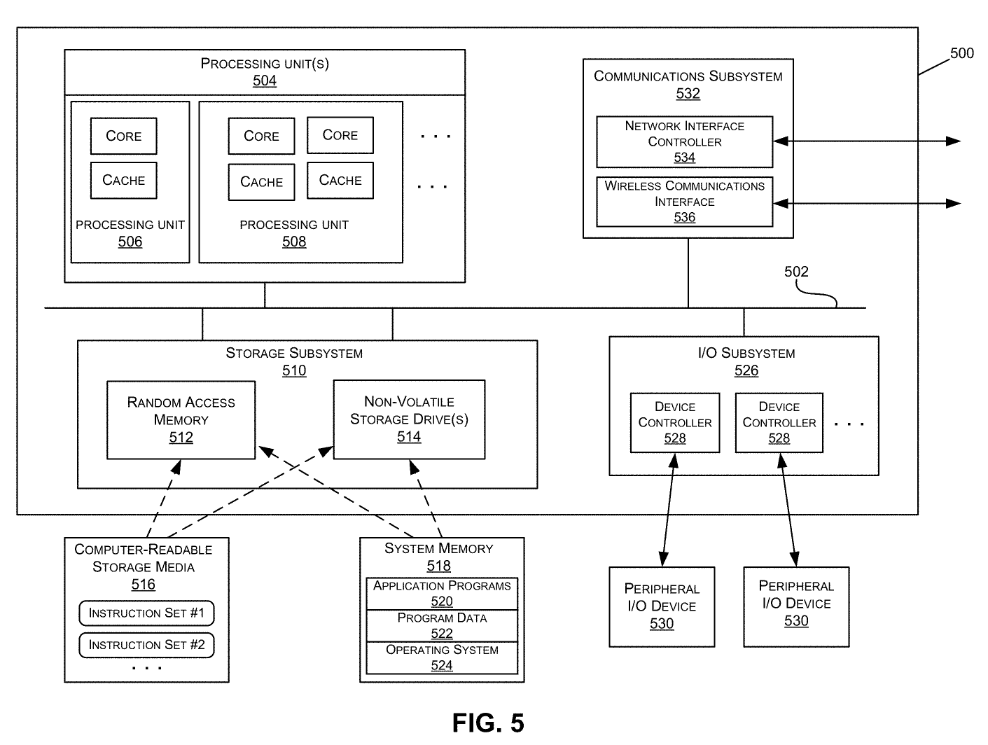

With reference now to FIG. 5, a block diagram of an illustrative computer system is shown. The system 500 may correspond to any of the computing devices or servers of the content distribution network 100 described above, or any other computing devices described herein. In this example, computer system 500 includes processing units 504 that communicate with a number of peripheral subsystems via a bus subsystem 502. These peripheral subsystems include, for example, a storage subsystem 510, an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in the figure, processing unit 504 may be implemented as one or more independent processing units 506 and/or 508 with single or multicore processors and processor caches included in each processing unit. In other embodiments, processing unit 504 may also be implemented as a quad-core processing unit or larger multicore designs (e.g., hexa-core processors, octo-core processors, ten-core processors, or greater.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some embodiments, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 530 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 318 may be stored in volatile memory (such as random access memory (RAM) 512) and/or in non-volatile storage drives 514 (such as read-only memory (ROM), flash memory, etc.) The RAM 512 may contain data and/or program modules that are immediately accessible to and/or presently being operated and executed by processing units 504. In some implementations, system memory 518 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality of some embodiments. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with the present invention.

Storage subsystem 300 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some embodiments, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third party information sources (e.g., data aggregators 309). Additionally, communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 532 may output such structured and/or unstructured data feeds, event streams, event updates, and the like to one or more data stores 104 that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

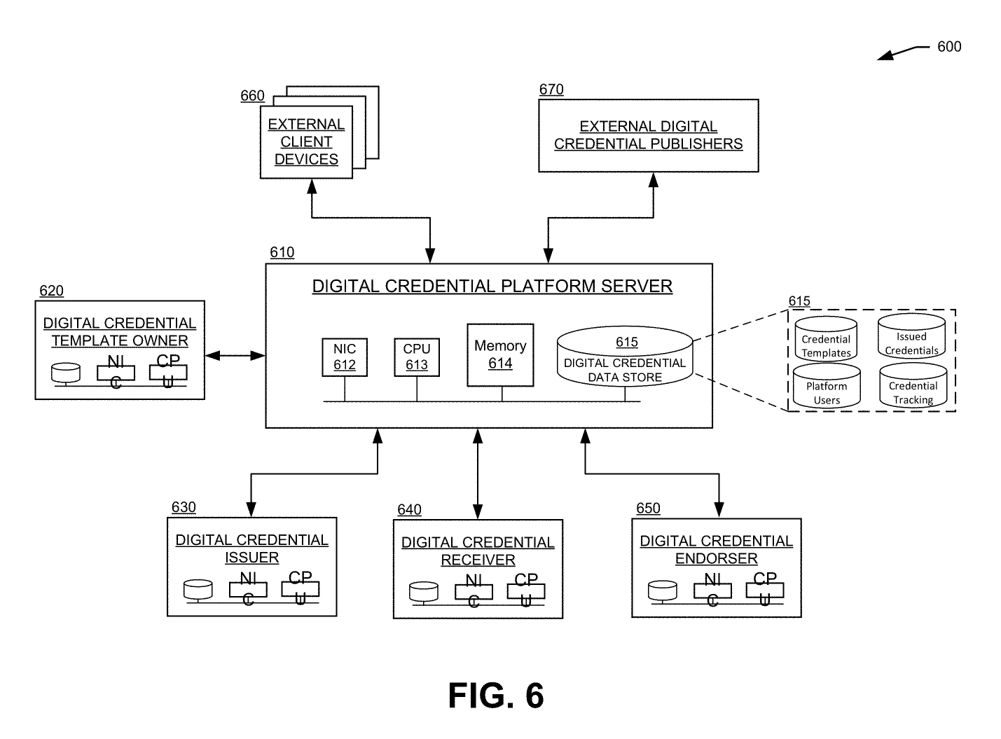

With reference now to FIG. 6, a block diagram is shown illustrating an example of a digital credential management system 600 for generating, managing, and tracking digital credential templates and digital credentials. As shown in this example, a digital credential management system 600 may include a digital credential platform server 610 configured to communicate with various other digital credential systems 620-680. As discussed below, the digital credential platform server 610 may receive and store digital credential templates from various digital credential template owner systems 620. Systems 620 may correspond to the computer servers and/or devices of educational institutions or professional training organizations, which may have the primary responsibility for defining a digital credential template and controlling the content and requirements for users to receive a digital credential from the organization. The digital credential management system 600 may include one or more digital credential issuer systems 630. As discussed below, each issuer system 630 may communicate with the platform server to request and receive access to issue digital credentials based on specific digital credential templates. The platform server 610 may process template access requests from the credential issuer systems 630, permitting or denying a specific system 630 to generate (or issue) a digital credential based on a specific digital credential template.

As used herein, a digital credential template (or digital badge template) may refer to an electronic document or data structure storing a general (e.g., non-user specific) template or description of a specific type of digital credential that may be issued to an individual. Digital credential templates may include, for example, a description of the skills, proficiencies, and/or achievements that the digital credential represents. This description may take the form of diploma data, certification data, and/or license data, including the parent organization (i.e., the digital credential template owner) responsible for creating and defining the digital credential template. Examples of digital credential templates may include templates for various technology certifications, licensure exams, professional tests, training course completion certificates, and the like. In contrast to a digital credential template, a digital credential (or digital badge) may refer to an instance of an electronic document or data structure, generated for a specific individual (i.e., the credential receiver), and based on a digital credential template. Thus, a digital credential document or data structure may be based on a corresponding digital credential template, but may be customized and populated with user-specific information such as individual identification data (e.g., name, email address, and other user identifiers), credential issuance data (e.g., issue date, geographic location of issuance, authorized issuer of the credential, etc.), and links or embedded data that contain the specific user's supporting documentation or evidence relating to the credential.

As shown in this example, the system 600 also may include a digital credential receiver system 640 and a digital credential endorser system 650. The digital credential receiver system 640 may be a computing device associated with a credential receiver (or credential earner), for example, an individual user of an electronic learning system, professional training system, online certification course, etc. In some embodiments, credential receivers may access the platform server 610 via systems 640 to accept or reject newly issued digital credentials, review and update their own set of previously earned digital credentials, as well as to publish (or share) their digital credentials via communication applications or publishing platforms such as social media systems. Digital credential endorser system 650 may be a computing system associated with an endorsing entity, such as an educational institution, business, or technical organization that has chosen to review and endorse a specific digital credential template. The platform server 610 may receive and track the endorsements received from systems 650, and may associate the endorsements with the user-specific digital credentials issued based on the endorsed templates.

Additionally, the digital credential management system 600 in this example includes a number of external client devices 660 and external digital credential publishers 670. External client devices 660 may correspond to computing systems of third-party users that may interact with the platform server 610 to initiate various functionality or retrieve data relating to templates and/digital credentials managed by the platform 610. For example, a client device 660 may query the platform server 610 for data metrics and/or analyses relating to a subset of digital credentials stored in the digital credential data store 615. The third-party systems 660 also may provide data to the platform server 610 that may initiate updates to the templates and/digital credentials stored in the data store 615. External digital credential publishers 670 may correspond to third-party systems configured to receive digital credential data from the platform 610 and publish (or present) the digital credential data to users. Examples of publishers 670 may include social media website and systems, digital badge wallets, and/or other specialized servers or applications configured to store and present views of digital badges to users.

In various embodiments described herein, the generation and management of digital credentials, as well as the tracking and reporting of digital credential data, may be performed within CDNs 100, such as eLearning, professional training, and certification systems 100. For example, within the context of an eLearning CDN 100, a content management server 102 or other CDN server (e.g., 104, 112, 114, or 116) may create and store digital credential templates to describe and define various proficiencies, achievements, or certifications supported by the eLearning CDN 100. Additionally or alternatively, the content management server 102 or other servers of an eLearning CDN 100 may issue digital credentials to users, based on its own digital certificate templates and/or templates received from other systems or CDNs. Further, in some implementations, an eLearning CDN 100 may be configured to include a digital credential platform server 610 to store and manage templates and digital credentials between separate systems within the CDN 100. Thus, in various different implementations, the content management server(s) 102 of a CDN 100 may incorporate one or more digital certificate template owner system(s) 620, digital certificate issuer system(s) 630, and/or digital certificate platform server(s) 610. In such embodiments, the various components and functionalities described herein for the platform server 610, owner system 620, and/or issuer system 630 all may be implemented within one or more content management servers 102 (and/or other servers) of an eLearning or professional training CDN 100. In other examples, a digital credential platform server 610 may be implemented using one or more computer servers, and other specialized hardware and software components, separately from any other CDN components such as content servers 112, content management servers 102, data store servers 104, and the like. In these examples, the digital credential platform server 610 may be configured to communicate directly with related systems 620-670, or indirectly through content management servers 102 and/or other components and communications networks of the CDN 100.

In order to perform these features and other functionality described herein, each of the components and sub-components discussed in the example digital credential management system 600 may correspond to a single computer server or a complex computing system including a combination of computing devices, storage devices, network components, etc. Each of these components and their respective subcomponents may be implemented in hardware, software, or a combination thereof. Certain systems 620-670 may communicate directly with the platform server 610, while other systems 620-670 may communicate with the platform server 610 indirectly via one or more intermediary network components (e.g., routers, gateways, firewalls, etc.) or other devices (e.g., content management servers 102, content servers 112, etc.). Although the different communication networks and physical network components have not been shown in this example so as not to obscure the other elements depicted in the figure, it should be understood that any of the network hardware components and network architecture designs may be implemented in various embodiments to support communication between the systems, servers, and devices in the digital credential management system 600. Additionally, different systems 620-670 may use different networks and networks types to communicate with the platform server 610, including one or more telecommunications networks, cable networks, satellite networks, cellular networks and other wireless networks, and computer-based IP networks, and the like. Further, certain components within the digital credential management system 600 may include special purpose hardware devices and/or special purpose software, such as those included in I/O subsystem 611 and memory 614 of the platform server 610, as well as those within the memory of the other systems 620-670, and the digital credential data store 615 maintained by the platform server 610, discussed below.

Although the various interactions between the platform server 610 and other systems 620-670 may be described below in terms of a client-server model, it should be understood that other computing environments and various combinations of servers and devices may be used to perform the functionality described herein in other embodiments. For instance, although the requests/responses to determine the authorized issuers 630 for specific digital credential templates, the generation of digital credentials, and the retrieval and presentation of digital credential tracking and reporting data, may be performed by a centralized web-based platform server 610 in collaboration with various client applications at the other systems 620-670 (e.g., web browser applications or standalone client software), in other cases these techniques may be performed entirely by a specialized digital credential platform server 610, or entirely by one or more digital credential tools (e.g., software services) executing on any one of the systems 620-670. In other examples, a client-server model may be used as shown in system 600, but different functional components and processing tasks may be allocated to the client-side or the sever-side in different embodiments. Additionally, the digital credential data store 615 may be implemented as separate servers or storage systems in some cases, and may use independent hardware and software service components. However, in other implementations, some or all of the digital credential data store 615 may be incorporated into the platform server 610 (as shown in this example) and/or may be incorporated into various other systems 620-670.

In some embodiments, each of the systems 620-670 that collaborate and communicate with the platform server 610 may be implemented as client computing systems, such desktop or laptop computers, smartphones, tablet computers, and other various types of computing devices, each of which may include some or all of the hardware, software, and networking components discussed above. Specifically, any of client systems 620-670 may be implemented using any computing device with sufficient processing components, memory and software components, and I/O system components for interacting with users and supporting the desired set of communications with the platform server 610, as described herein. Accordingly, client systems 620-670 may include the necessary hardware and software components to establish the network interfaces, security and authentication capabilities, and capabilities for transmitting/receiving digital credential templates and digital credentials, digital credential data requests/responses to the platform server 610, etc. Each client system 620-670 may include an I/O subsystem, network interface controller, a processing unit, and memory configured to operate client software applications. The digital credential platform server 610 may be configured to receive and execute various programmatic and graphical interfaces for generating, managing, and tracking issued digital credentials, in collaboration with the various client systems 620-670. Accordingly, each client system 620-670 may include an I/O subsystem 611 having hardware and software components to support a specific set of output capabilities (e.g., LCD display screen characteristics, screen size, color display, video driver, speakers, audio driver, graphics processor and drivers, etc.), and a specific set of input capabilities (e.g., keyboard, mouse, touchscreen, voice control, cameras, facial recognition, gesture recognition, etc.). Different client systems 620-670 may support different input and output capabilities within their I/O subsystems, and thus different types of user interactions, and platform server 610 functionality may be compatible or incompatible with certain client systems 620-670. For example, certain types of digital credential generation and search functionality may require specific types of processors, graphics components, network components, or I/O components in order to be optimally designed and constructed using a client system 620-670.

In some embodiments, the digital credential platform server 610 may generate and provide software interfaces (e.g., via a web-based application, or using other programmatic or graphical interface techniques) used by the various client systems 620-670 to perform the various digital credential management functionality described herein. In response to receiving inputs from a client system 620-670 corresponding to digital credentials, templates, credential search requests and criteria, etc., the platform server 610 may access the underlying digital credential data store 615 perform the various functionality described herein. In other to perform the tasks described herein, platform server 610 may include components such as network interface controllers 612, processing units 613, and memory 614 configured to store server software, handle authentication and security, and to store, analyze, and manage the digital credentials, templates, and credential tracking data stored within the digital credential data store 615. As shown in this example, the digital credential data store 615 may be implemented as separate dedicated data stores (e.g., databases, file-based storage, etc.) used for storing digital credential template objects, issued digital credentials, credential tracking data, and authorized user/role data. The platform server 610 and data store 615 may be implemented as separate software (and/or storage) components within a single computer server 610 in some examples, while in other examples may be implemented as separate computer servers/systems having separate dedicated processing units, storage devices, and/or network components.

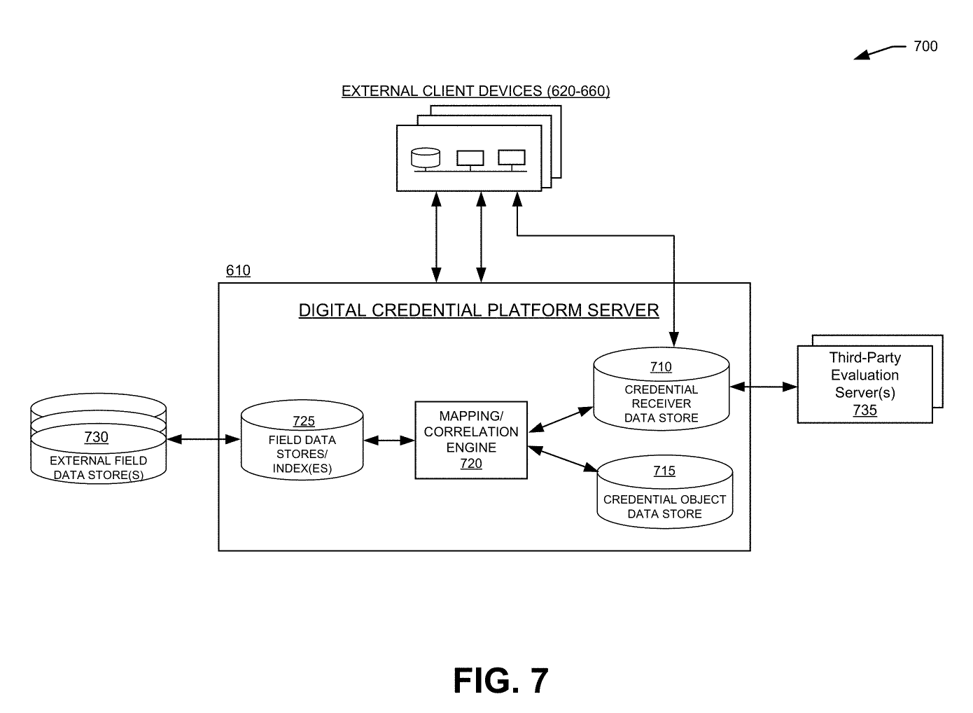

Referring now to FIG. 7, a block diagram is shown illustrating an example of digital credential receiver mapping system 700. As described below, in this example, the components of digital credential receiver mapping system 700 may be configured to determine mappings and score the level of correlations between particular digital credential receivers (or digital badge earners) and corresponding fields/occupations. As discussed below in detail, the correlation analyses between mappings credential receivers and fields may be based on multiple types, dimensions, and sources of verified data stored and maintained the a digital credential platform server 610, including receiver data stored in credential receiver data store 710, digital credential data stored in a digital credential object data store 715, and field/occupation data stored in a field data store 725. In addition to performing correlation analyses and determining mappings/scores between credential receivers and fields, system 700 also may be configured to receive and respond to requests from various client devices 620-660. For example, as discussed in more detail below, a client device 620-660 may transmit a request to a digital credential platform server 610 identifying a particular digital credential receiver, and may receive back from platform server 610 data identifying one or more fields that correlate highly to digital credential receiver, based on the receiver's issued digital credentials, verified evaluation records, and/or other relevant data. Conversely, a client device 620-660 may transmit a request to the platform server 610 identifying one or more fields (e.g., a technical field, occupation, and/or particular job listing), and may receive back from platform server 610 data identifying one or more digital credential receivers that correlate well to the characteristics of the fields/occupations/listings identified in the request.

In some examples, a digital credential receiver mapping system 700 may be implemented within the same system 600 described above in FIG. 6. That is, the same digital credential platform server 610 may be used to perform to the generation, management, and tracking of digital credentials and templates discussed above, as well as the mapping of digital credential receivers to fields as shown in these examples. Thus, the digital credential object data store 715 also may correspond to data store 615, and external client devices 620 may correspond to the same system components 620-660 described above. However, in other examples, digital credential receiver mapping system 700 may be implemented entirely separately from any digital credential management system 600. For instance, in some embodiments, system 700 need not include any credential receiver data store 710, digital credential object data store 715, or field data stores/indexes 725, or the associated functionality for issuing, storing, managing, or tracking receiver data, credential objects, etc. Instead, in such embodiments, the system 700 might only access and retrieve credential receiver data, credential object data, field data, etc., from external data sources (e.g., a remote digital credential management system 600).

As described below in more detail, the credential receiver-field mapping correlation engine, or mapping engine 720, may retrieve and analyze data from multiple data sources, including credential receiver data store 710, digital credential object data store 715, or field data stores/indexes 725, to determine correlations between particular credential receivers and fields. In some embodiments, the various sources of credential receiver data may be secured and verified, such as verified evaluation results relating to the credential receiver received from a third-party system 735 and stored in credential receiver data store 710, and/or the verified issued digital credential data stored in the credential object data store 715. Such secured and verified sources of data may provide assurances to the client devices requesting the receiver-field analyses/correlations, and to the other parties interacting via the system 700 (e.g., digital template owners, credential issuers, credential receivers, credential endorsers, etc.), that they analyses performed and the matches/correlations determined between particular badge earners and fields/occupations are valid, accurate, current, and have not been manipulated by any of the parties involved.

In some embodiments, the field data objects stored in data stores/indexes 725 may correspond to fields of work, such as types or classes of occupations. For example, external field data stores(s) 730 may include occupation databases such as the O*NET® database, or another occupation data store containing variables that describe work and/or worker characteristics. Data stores 730 may store, for instance, skill requirements, education and training requirements, worker abilities and characteristics, and/or related technologies for a large taxonomy of occupations. As discussed below in more detail, the digital credential platform server 610 may be configured to access and retrieve specific field data (e.g., occupation characteristics, skills, abilities, technologies, education and training requirements, etc.) from the external data stores 730, and to store that data within one or more local data structures such as field data object indexes 725. In some embodiments, to increase the speed in which correlations/mappings may be determined and scored between digital credential receivers and fields, the platform server 610 may preprocess and import, and/or index the field data in advance of receiving any requests from client devices 620-660. However, in other examples, in the platform server 610 may rely entirely on external field data stores 730, and need not import or preprocess any field/occupation data into any local storage structures 725. Thus, field data object data stores/indexes 725 may be optional in certain implementations.

The data received from various different third-party evaluation servers 735 may include any other type of relevant user data associated with the credential receivers, other than the credential data itself which is maintained in data store 715. Such credential receiver data may include, for example, clinical assessment data, personality and/or career interest test data, psychological evaluation data, and the like. Thus, third-party evaluation servers 735 may correspond to the secure computing systems of educational facilities, testing centers and/or secure websites configured to administer such tests to users. These facilities may include formal testing locations, simulation labs, and/or qualified personnel (e.g., a specialized doctor, clinician, or educator) to measure particular personality characteristics, psychological traits, and interests of the particular user. In some cases, the user (e.g., a digital badge earner) may interact with a formal testing data source via a client device 640, either directly or indirectly through the platform server 610, in order for the testing/evaluations to be performed. Such external data sources 735 may include doctor's offices, therapists, etc., which may provide (when authorized, and transmitted securely) previous clinical diagnoses of the user. Other types of third-party evaluation sources 735 may include analyses systems configured to perform on-the-job monitoring and evaluation of a user's actions and reactions while working, studying, and/or during normal daily interactions. Finally, third-party evaluation data sources 735 may include any other data source with relevant personality-related data may be retrieved and analyzed to identify personality traits of the user with a sufficiently high degree of confidence. For instance, additional data sources 735 may include email servers and documents stores from which the user's documents, emails and other communications (e.g., text messages, voicemails, instant messages, etc.) may be retrieved and analyzed to determined communication styles and personality traits. In some embodiments, third-party sources 735 also may include financial servers (e.g., to obtain the user's bank statements), educational record servers (e.g., to obtain the user's grades, transcripts, disciplinary issues), governmental servers (e.g., to obtain the user's criminal record, etc.), all of which may be analyzed in conjunction with the other data sources to identify relevant personality traits of the user.

As noted above, the mapping engine 720 may retrieve and analyze data for a particular credential receiver, including both the digital credentials issued to the receiver (from 715) and various other relevant data retrieved from verified third-party sources 735, in order to determine the closest correlations between the particular credential receiver and various fields/occupations. For instance, a set of the most highly correlated personality/interest characteristics associated specific fields/occupations may be derived from a statistical distribution of different data fields (e.g., characteristics, abilities, technologies, education and training requirements, etc.) across the field/occupation data store 725, and/or using external data sources including statistics for credential receivers currently or previously employed within the different fields/occupations, such as employment data, performance data, and corresponding personality/interest data of existing or previous workers. The techniques and algorithms used by the mapping engine 720 to determine correlations and calculate scores between digital credential receivers and fields/occupations are discussed in more detail below.

As shown in this example, the mapping engine 720 may be implemented as a processing component within the platform server 610. However, in other examples, the mapping engine 720 may be implemented separately from the platform server 610 and may operate as an independent system with direct access to one or more credential receiver data stores 710, credential object data stores 715, and one or more field data object stores 725. Additionally, although the mapping engine 720 and data stores 710, 715, and 725 are shown separately in this example, they may be implemented as a single data storage/processing engine in some embodiments. For example, data stores/indexes 710, 715, and 725 may be implemented as high-speed index storage platforms that include indexing and searching capabilities, as well as advanced tokenization and data analysis. Such data storage indexes 725 support various different search query types (e.g., phrase search queries, proximity queries, range queries, fuzzy searches, wildcard searches, etc.), and may support various ranking functions using Boolean term matching, vector space modeling and/or other probabilistic ranking functions. In these cases, the credential receiver data store 710, credential object data store 715, and/or field data object store 725 may include a mapping space modeling engine 720 as an integrated component of the high-speed storage platform.

System 700 may support requests from various client devices for data analyses/correlations (e.g., in the form of mappings, scores, and/or highest-ranking subsets, etc.) between digital credential receivers (e.g. digital badge earners or other individual users associated with a set/portfolio of digital credentials and/or other data), and corresponding fields data objects (e.g., representing fields, occupations, and/or individual job listings, etc.). Examples of potential client devices that may request a set of fields based on credentials (or vice versa) may include digital credential owners 620, digital credential issuers 630, digital credential receivers 640, digital credential endorsers 650, and/or other external client devices 660. In some embodiments, the system 700 may support different interfaces (e.g., web-based graphical interfaces, web services, and/or APIs) based on the type/role of the particular client device. For instance, certain types of client devices may be authorized to provide user identifiers or digital credential receiver identifiers and retrieve corresponding field mappings, but might not be permitted to request digital credential receivers based on fields, whereas other types of client devices may have the opposite authorizations. Additionally, as discussed below, some embodiments may involve multiple credential receiver data stores 710, digital credential object data stores 715, and/or multiple field indexes 725. In such embodiments, security and permissioning systems may be used to govern which corresponding secure receiver data stores, field data stores, and/or digital credential stores are used for serving requests from particular clients. For instance, a first client 620 may be authorized to retrieve receiver-field mappings from one portion of a field data object index 725 corresponding to a first external field database 730a, but not from other portions of the index 725 that correspond to other external field databases 730b. Similarly, another client 620 may be authorized to retrieve receiver-field mappings based on one receiver records/credentials from certain receiver data stores 710 and credential stores 715, but might not have access to other sources or receiver/credential data.

Further, depending on the type/role of a particular client 620-660, the platform server 610 may accept different data within a request (e.g., a credential owner ID for a credential owner client 620, a credential issuer ID for credential issuer client 630, a credential recipient ID for a credential receiver client 640, or a set of digital credential template IDs from any external client, etc.), and/or may return different data fields and formats in the response to the client device 620-660.

Additionally, certain clients 620-660 may have ownership or administrative control over certain digital credential templates and/or issued digital credential stored in the data store 715. For example, a particular credential receiver (or digital badge earner) 640 may control the use of its own credential receiver data within the store 710 and own issued credential objects within store 715, but not other credential receiver data or credential objects issued to other receivers. Alternatively, in some embodiments, the system 700 may implement layers of security and verification associated with digital credential receiver data stored in data store 710 and/or the issued digital credential object data stored in data store 715, which may restrict access to these data in order to provide assurances that the data are current, accurate, secure, and third-party verified in some or all cases. For instance, in some cases, a particular digital badge earner 640 might have access to view, but not to modify, their own third-party evaluation records in data store 710. The same security rules may be applied to issued digital credentials in stored in data store 715, so that these records are verified, secured, and not subject to unauthorized modification (which may be linked to fraud or manipulation of the algorithm) by the digital badge earner or any other unauthorized party.

In some cases, digital badge earners 640 may be prevented from even viewing their evaluation results records from data store 710 and/or their issued credentials from data stores 715, in order to prevent attempts by a user to obtain other evaluations, start other accounts/profiles, or to otherwise manipulate the correlation analysis processes. However, in other cases, digital badge earners 640 and other users may be authorized to view their evaluation results data and/or their digital credentials, and also may be permitted to initiate correlation analyses based on hypothetical modified data. For instance, a digital badge earners 640 might not be permitted to modified any of their actual verified personality data, trait data, interest data, etc., stored within the data store 710, but may be permitted by the platform server to setup a hypothetical profile with modifications to their personality/trait/interest data, and then to run a field correlation analysis to retrieve a set of matching/correlated fields/occupations for the hypothetical profile. Similarly, in some embodiments, digital badge earners 640 may be permitted to make hypothetical modifications to their portfolio of issued badges stored in data store 715, and then initiate a field correlation analysis to retrieve a set of matching/correlated fields/occupations based on their updated set of digital badges.

While certain embodiments may include retrieving/extracting field/occupation/job data from a single external data store 730, in other embodiments the platform server 610 may access multiple different external data stores 730 containing different sets of field/occupation/job data. In some cases, the platform server 610 may aggregate field data across multiple different occupation data stores 730. For instance, the platform server 610 may access multiple occupation data stores 730 (e.g., O*NET® database, Bureau of Labor Statistics (BLS) governmental databases, etc.) and may aggregate the different data fields (e.g., skills, abilities, technologies, education and training requirements, etc.) across the different data stores 730 into single fields within the index 725. In other cases, data from different external data stores 730 need not be aggregated, but may be stored separately and used to serve different requests. For example, different occupation data stores 730 may be associated with different geographic region (e.g., states, countries, etc.), so that requests received from a client 620-660 in a particular geographic region will be served by the index 725 using only the data from the store 730 of the same geographic region.

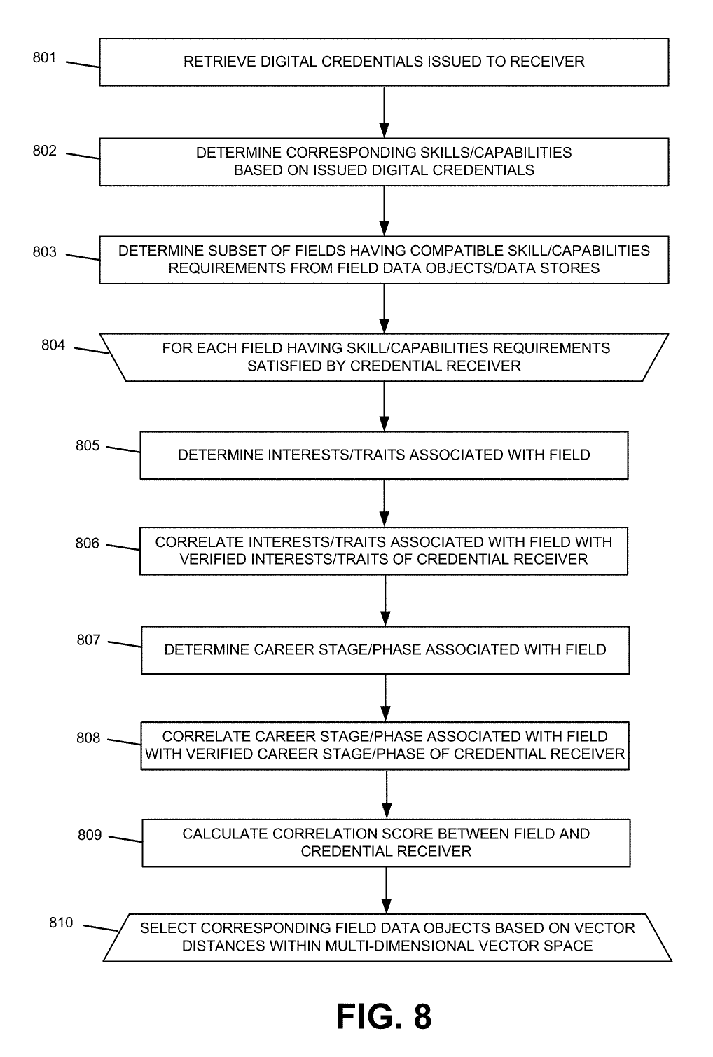

Referring now to FIG. 8, a flow diagram is shown illustrating a process of analyzing digital credential receiver data and issued digital credential data, and then correlating/mapping credential receivers to one or more field data objects. As described below, the steps in this process may be performed by one or more components in the digital credential receiver mapping system 700 described above. For example, each of steps 801-810 may be performed by a digital credential platform server 610 (and/or mapping engine 720), in communication with one or more external or internal data stores 710, 715, and 725. However, it should be understood that the various features and processes described herein, including retrieving verified credential receiver data, correlating digital credentials to skills/capabilities, correlating verified third-party receiver data to personality/traits/interests, and then determining and scoring a subset of fields/occupations most correlated with the credential receiver, need not be limited to the specific systems and hardware implementations described above in FIGS. 1-7, but also may be performed on the various other systems and hardware implementations described herein.

In step 801, the digital credential platform server 610 may retrieve a set of digital credentials issued to a particular digital credential receiver (or digital badge earner). The digital credential data may be retrieved from one or more credential object data store 715. As noted above, the retrieval of the badge earner's digital credentials in step 801 may be performed in response to a request for a set of fields/occupations with high correlations to the badge earner's skills, personality/interests, career stage, and/or other relevant factors. Such requests may identify a particular digital badge earner, or alternatively may identify one or more digital badges rather than the earner of the badges. Requests for sets of fields/occupations that correlate with a badge earner's data may be initiated by various different types/roles of users, including digital credential issuers, receivers, potential employers or recruiters, etc., through their respective portals and user interfaces. When a request identifies a particular badge earner, the platform server 610 may retrieve all digital credentials issued to that particular earner from the credential data store 715. The badge earner may have been issued a single badge only, or a set (or portfolio) of multiple different badges, which may be related/complimentary or unrelated to one another.

In step 802, the platform server 610 may use the digital credential data retrieved in step 801 for the credential receiver, in order to determine the corresponding set of skills/capabilities of the receiver. As discussed above, digital credentials or digital badges may correspond to certifications, completions of training courses or educational programs, and/or verified assurances of particular skill sets. Each digital credential may be associated with one or more skills or capabilities, where it may be assumed that all receivers of the digital credential possess the corresponding skills/capabilities.

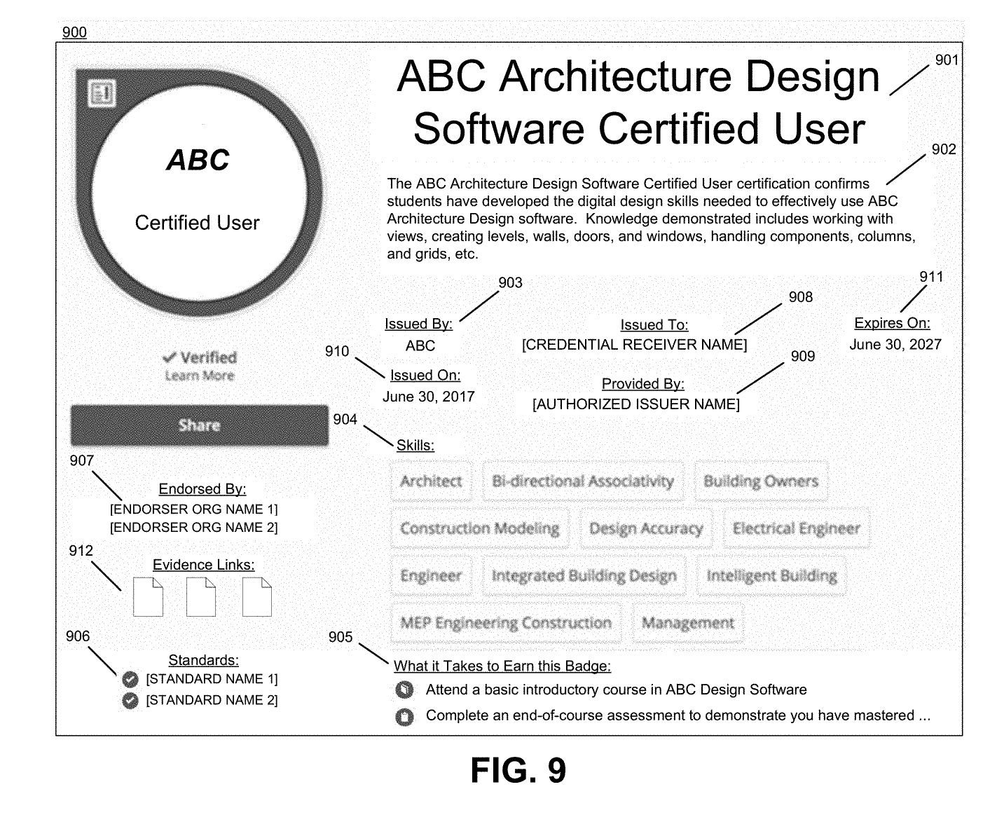

In some cases, the skills/capabilities associated with a particular digital credential may be stored in the issued digital credential object (or in the corresponding digital credential template). For example, referring now briefly to FIG. 9, an example user interface screen is shown displaying a digital credential view (or badge view) of an issued digital credential 900 verifying by the issuer that the credential receiver is an “ABC Architecture Design Software Certified User.” In this example, the digital credential 900 displays a combination of data from the underlying credential template, along with data customized to the specific receiver and/or specific issuer during the issuance process. The data from the from the underlying credential template may include such data as the credential title 901, description 902, issuer 903, skills 904 associated with the digital credential template, accomplishments/requirements 905 associated with earner the digital credential, a set of technical standards 906 associated with the digital credential, and a set of endorsements 907 of the digital credential template. The set of endorsements 907 may identify one or more endorsing entities 650, such as educational institutions, businesses, or technical organizations that have chosen to review and endorse specific digital credential templates. The digital credential data retrieved in step 802 also may include additional data fields that are customized to the specific receiver and/or specific issuer during the issuance process, such as the credential receiver name 908, authorized issuer name 909, credential issue date 910, credential expiration date 911, and embedded links 912 to user-specific documentation supporting the digital credential. In various embodiments, any combination of these digital credential fields may be used in the analyses and correlations between the digital credential receiver and field data objects, as described below.

Thus, by retrieving and analyzing the various fields in digital credential objects and/or templates, the platform server 610 may determine a set of corresponding skills for the receiver in step 802. Additionally or alternatively, the platform server 610 also may use data outside of the digital credentials themselves, such as separate credential-skill correlation tables, or empirically-based data stores that link the earners of particular digital credentials to related skills/capabilities using survey data, job performance data, verified testing, etc.

Additionally, in some embodiments, the badge issued data 910 and/or badge expiration data 911 may be used by the platform server 610 in the determination of a badge earner's presumed skills/capabilities. For example, the platform server 610 may apply weights and/or multiplier factors that increase the determined skills/capabilities for recently earned badges and lower the determined skills/capabilities for older badges that are closer to their expiration date. Additionally, when a receiver has earned multiple credentials that identify or related to the same skill/capabilities, the platform server 610 may take this into account by multiplying the receiver's presumed level of that skill by a multiplier factor for each additional credential relating to the same skill.

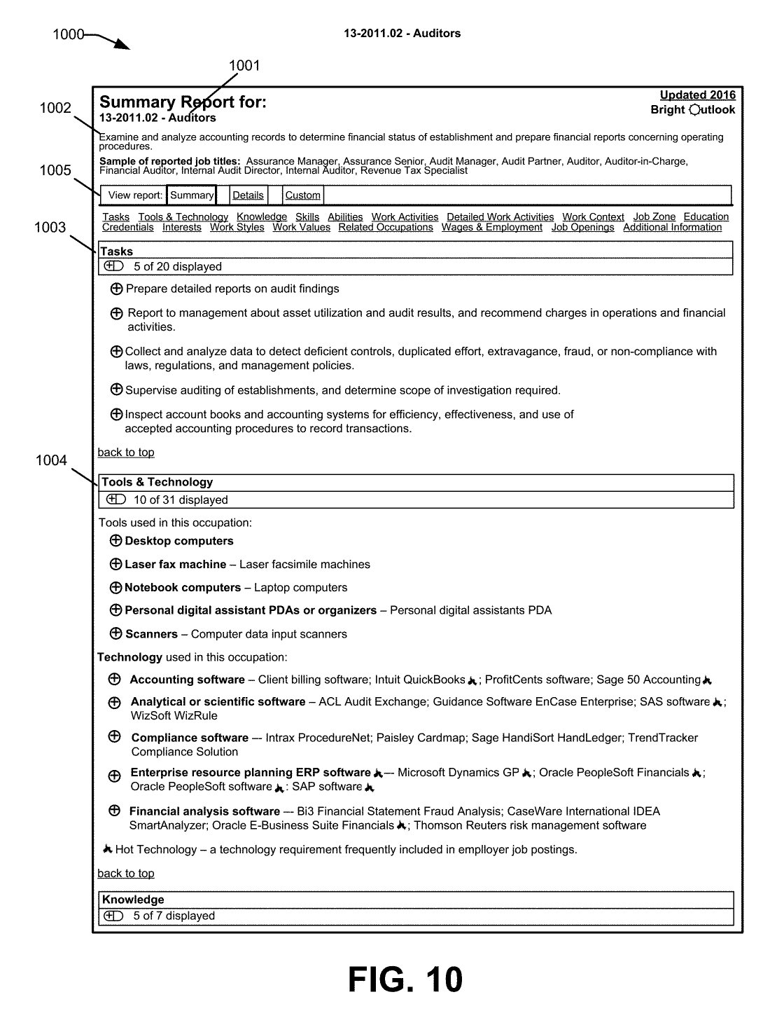

In step 803, the mapping engine 720 and/or other components within the platform server 610 may select one or more of the field data objects from the data store/index 725, having sets of skills/capabilities that most closely match those skills/capabilities determined for the receiver in step 802. Thus, step 803 may initially include accessing and querying the field data store/index 725 (or one or more external data stores 730) with the set of skills/capabilities determined in step 802. As noted above, field data stores/indexes 725 and external field data stores 730 may contain a hierarchy and listings of field/occupation data. Such data stores 730 may include, for example, one or more O*NET® databases, one or more Bureau of Labor Statistics (BLS) governmental databases, and/or other various field/occupation data stores. In certain embodiments, databases of job listings may be specifically excluded from the accessed data stores 730, because job field or occupation data stores may use standard and uniform terminology, whereas job listing databases might not. However, in other embodiments, the platform server 610 also may access and retrieve data from job listing databases, and may use algorithms to classify and group individual job listings into the appropriate occupations/fields. Such algorithms may include mapping job listings having different titles, descriptions, and characteristic to the same field/occupation based on subject matter analysis and generation/matching of synonyms for keywords within the job listings. For example, referring briefly to FIG. 10, an example occupation listing web document 1000 is shown from an O*NET database corresponding to the “Auditor” field (or occupation). In this example, document 1000 may be formatted in accordance with a known O*NET document format, including separate data fields at predetermined locations within the document 1000 that display the title 1001 of the field/occupation, a description 1002 of the field/occupation, a set of tasks 1003 associated with the field/occupation, a set of related tools and technologies 1004 associated with the field/occupation, and several additional data fields accessible via tabs and links 1005 to provide additional data relating to the field/occupation.

The algorithms and other techniques used in step 803 may query for and/or retrieve a plurality of web documents such as the example O*NET document 1000 (or any other field/occupation listings), and then may extract and parse data from these documents or listings corresponding to the skills and capabilities that may be required for individuals to perform the associated occupation. For each field/occupation document or listing retrieved, the platform server 610 may initially identify and separately extract each of the particular relevant data fields from the document. For instance, using the example O*NET document 1000, the platform server 610 may separately extract the title field 1001, description field 1002, task field 1003, tools/technologies field 1004, etc., so that each of these fields may be analyzed and processed separately using custom processes for that particular data field. In some embodiments, certain data fields (e.g., the description 902 and/or tasks 903) may be parsed by the platform server 610 to extract out specific individual keywords from those data fields relating to the skills or capabilities of the associated occupation. Each of the individual keywords then may be submitted to processes for stemming, preprocessing, and/or identifying synonyms or substitute related terms. For example, referring to the description 1002 of the example document 1000, the term “Examine” may be stemmed to the root “examin” in order to match the terms “examined,” “examiner,” “examining,” etc. As another example, “management” may be stemmed to “manag,” so as to include the related terms “manage,” “manager,” etc. Additional stemming/preprocessing steps for terms found in the example document 1100 may include formatting processes such as removing apostrophes, converting to lower case, standardizing any spacing or numbers within the term, etc. Further, the stemmed and preprocessed term (and/or the related derivative terms) may be used to determine synonyms or other related terms (e.g., “inspect,” “evaluate,” “review,” etc.). Moving on to the second word in the description 1002 (“and”), the platform server 610 may discard this word, along with any other stock words, connector words, and other words determined to be irrelevant to the digital credential mapping. The platform server 610 then may move on to perform the same processes of stemming, preprocessing, and generating related terms on the third word “analyze” and the fourth word “accounting,” and so on.

In some cases, the platform server 610 may be configured to detect multi-word keywords within a data field that correspond to a single skill or capabilities. For example, when parsing the tools field 1003 of the field/occupation document 1000, the platform server 610 may determine that the term “Laser fax machine” should be stored as a single multi-word term that may be related to the capabilities required for the occupation, rather than as the separate individual terms “laser,” “fax,” and “machine.” In some embodiments, the platform server 610 may first identify any known and/or common multi-words terms found within a field (e.g., “financial analyst,” “desktop computer,” “compliance software,” etc.), and then may process any remaining terms from the field as single-word terms. Additionally, the platform server 610 may be configured in some embodiments to identify and process multi-words terms only in certain fields (e.g., tasks 1003, tools/technologies 1004), but not in other fields (e.g., description 1002).

The mapping engine 720 may identify a single field/occupation data object in step 803, or may identify a subset of multiple high-ranking field/occupation data objects based on the matching of the receiver's skills/capabilities to the corresponding skills/capabilities of the field/occupation/job. For example, field data objects may be selected from data stores 725 and/or 730 based on matching at least a threshold number of skills/capabilities, a threshold percentage skills/capabilities, or based on a determination that the receiver possesses all of the skills/capabilities required for the occupation. In some embodiments, the selection of the most correlated field/occupation data objects in step 803 need not be based solely on the number of matching skills/capabilities, but also may include skill levels or weightings of the receiver's skills. Further, in certain embodiments, the mapping engine 720 also may take into account one or more additional factors such as field/occupation income, geography, the number of currently available job postings matching the field/occupation, etc. For instance, when the platform server 610 determines that one or more of these additional factors is present for a particular field/occupation data object, it may apply one or more weighting multipliers that will result in the field/occupation data object being more likely to be selected for inclusion in the subset in step 803.

Steps 804-810 represent a subroutine that may be performed for each of the field data objects selected in step 803. As noted above, each field data object selected in step 803 may have a required set of skills/capabilities that correspond to those of the digital credential receiver (or digital badge earner). In steps 804-810, additional types and sources of data related to the credential receiver may be analyzed with respect to field data object, in order to determine additional dimensions of correlation such as personality/interest/trait correlation, career state correlation, etc.

In step 805, for a particular field data object identified in step 803, the mapping engine 720 of the platform server 610 may determine a set of interests or traits associated with the field/occupation. The interests/traits associated with a particular field or occupation may include the set of personality characteristics, interests, interpersonal communication styles, and/or psychological traits that have been empirically determined to be effective interests/traits for the particular field or occupation. Such measures of effectiveness may refer to effectiveness of the match between an individual and occupation from the perspective of a potential employee (e.g., worker satisfaction, longevity, health-based and stress-based metrics, etc.), and/or from the perspective of the potential employer (e.g., hiring rate, longevity of employment term, employee productivity or performance metrics, etc.). In some cases, such interest/trait data may be stored directly in the field data objects within data stores 725 and 730. For example, specific fields within a document (e.g., 1000) may identify the optimal personality traits, interests, or psychological characteristics of individuals who best fit the field/occupation. Additionally or alternatively, the platform server 610 may retrieve such interest/trait data for particular fields/occupations from various third-party data sources, such as clinical sources, employee-workforce survey sources, trade journals, medical/psychological studies, etc.

As noted above, the personality traits/interests determined for a badge earner may be fully verified and objective data, such as clinical assessment data, personality and/or career interest test data, psychological evaluation data, etc. However, in some embodiments, the personality traits/interests may include non-verified data and/or partially verified data instead of or in addition to such verified data. For example, determining a user's personality and/or interest data in step 805 may include analyzing usage data from the user's electronic devices (e.g., mobile applications, wearable devices, health and activity monitors, automated analyses of the user's emails and other communications, etc.).

In some cases, the types of personality trait/interest data determined for a particular user also may include soft skills, such as leadership skills, communication skills, teamwork skills, critical thinking skills, positive/negative attitude, work ethic, etc. These soft skills may be determined for a badge earner using verified techniques (e.g., clinical assessments and evaluations) and/or using the other techniques discussed above. Additionally, in some embodiments, the platform server 610 may support the creation and issuance of digital credentials/badges associated with any of personality traits/interests discussed above. Such personality/trait badges may be based on credential templates and may have a digital credential view similar to the example digital credential 900.

In step 806, the sets of personality traits/interests determined in step 805 for the particular field may be compared to the various interest/trait data for the digital credential receiver, to provide an additional dimension of matching/correlation analysis between the receiver and the field/occupation. As described, the various interest/trait data for the digital credential receiver may be stored in the credential receiver data store 710 and/or may be retrieved from third-party servers 735. The different types of personality trait/interest data for the digital badge earner that may be retrieved and used in step 806 may include any or all of the credential receiver data discussed above, for instance, clinical assessment data, personality and/or career interest test data, psychological evaluation data, automated analyses of the user's emails and other communications, etc.

In various embodiments, the determination and correlation of interests/traits in steps 805-806 may be based on one or more standard personality assessments. For instance, both the digital badge earners and the corresponding fields/occupations may be evaluated in terms of a standard five factor model (FFM) of personality, which describes the breadth of human personality as the blending of the following five different dimensions:
a. Openness to Experience
b. Conscientiousness
c. Extraversion
d. Agreeableness
e. Neuroticism

Independent research studies which have been performed and are still ongoing, have linked specific combinations of these dimensions to affinity and performance in specific fields/occupations. For example, while conscientious is generally a high predictor of job performance, research has shown that a high-level of conscientiousness might not be optimal for all fields/occupations, such as for occupations that require a high-degree of cognitive ability. Thus, each different field/occupation may be associated with an ideal mix of these personality traits.

In some embodiments, the correlative analysis performed by the mapping engine 200 in step 806 may be based on proxy data referred to as vocational interests, which have been researched and linked to the FFM. In some examples, a set of vocational interests called Holland Codes may be used, which include the following six categories (referred to by the acronym RIASEC).
a. Realistic
b. Investigative
c. Artistic
d. Social
e. Enterprising
f Conventional

In such embodiments, the mapping engine may create an interest vector RIASEC(O, x1,x2,x3,x4,x5,x6) for each field/occupation, showing the occupation code and interest index best correlated to a successful candidate. For example, an ONET database or other field data store 725 or 730 may store interest ranges (from x to y) indicating how important each dimension is to each occupation. Additionally, a corresponding RIASEC(y1,y2, y3, y4, y5, y6) interest vector may be generated for the particular digital badge earner, using the data collected from a career interest survey. These two vectors may be compared in step 806, and the resulting calculation of the vector comparison may reflect the interest fit to the occupation. A better interest fit may increase the overall correlation score, while a lower interest fit may decrease the overall correlation score.

Steps 807-808, which may be optional in some embodiments, may provide another dimension of the correlation analysis, by comparing the current career stage of the digital credential receiver to a career stage of each of the field data objects identified in step 803. For example, even if a particular field or occupation is determined to be a skills match and a high interest fit for a particular badge earner, the field/occupation may be entry level while the digital badge earner is an older and/or more senior worker, or vice versa. In such cases, the detection of a low career stage fit may decrease the overall correlation score. When a high career stage fit is determined, indicating that the current career stage of the digital badge earner is appropriate for the field/occupation, the overall correlation score may be increased. The effect of these decreases/increases of the overall correlation score based on career stage is to improve the overall mapping process to better identify the fields/occupations that are appropriate for the digital credential receiver taking into account the receiver's age and/or current stage in their career.

In order to implement this additional dimension of the correlation analysis, in step 807, the mapping engine 720 may either retrieve or determine a career stage associated with the field data object. In some cases, the field data object itself (e.g., an ONET document or other field/occupation document 1000) may store career stage information associated with the field or occupation (e.g., entry level versus mid-level versus senior level, number of years of experience required, management responsibilities, etc.). In other cases, the platform server 620 may analyze various text/data fields of the field data object (e.g., responsibilities, technologies used, job title, salary, educational requirements, etc.) to make a determination of the presumed career stage. Additionally or alternatively, the platform server 610 may retrieve career stage/phase data from one or more external data stores (e.g., worker surveys, worker age databases, etc.). Then, in step 808, the appropriate career stage(s) associated with the field or occupation may be compared to the current career stage of the digital credential receiver. As noted above, the comparison in step 808 may be used to increase or decrease the overall correlation score in some cases, to better match credential receivers with appropriate occupations for their current career stage. In other cases, rather than increasing or decreasing the correlation score, the comparison in step 808 may serve as a filter which excludes any field/occupation from the subset identified in step 803 that does is not an appropriate career stage match.

In step 809, the mapping engine 720 of the platform server may calculate a correlation score for each of the field data objects identified in step 803. As noted above, the correlation score calculated in step 809 may be based on a combination of the multiple verified data sources and correlative analyses comparing the particular credential receiver to the fields/occupations represented by the field data objects. Thus, the calculation step 809 may be based on a combination of at least: (a) the degree/level of correlation in the receiver's skills in comparison to the skills of the particular field/occupation (step 803); (b) the degree/level of correlation in the receiver's personality traits/interests in comparison to the traits/interests associated with the particular field/occupation (step 806); and (c) the degree/level of correlation in the receiver's current career stage in comparison to the associated career stage/phase of the particular field/occupation (step 808). Thus, the resulting overall correlation score between the badge earner and field/occupation may take into account each of these separate dimensions of capability. Additionally, in various embodiments, additional data sources may be retrieved and further correlation analyses between badge earner data and field/occupation data may be included in the calculation, such as a comparison of the current or preferred geographic regions (e.g., states, countries, etc.) of the badge earner to those of the field/occupation, or various language abilities/requirements, minimum education levels, salary expectations or requirements, etc.

Various different algorithms and/or other computational techniques may be used to calculate the correlation score in step 809. In some embodiments, a vector space analysis and/or vector angle analysis may be performed between the data associated with the particular credential receiver (e.g., issued credentials) and the data associated with the fields/occupations (e.g., occupation listing web document, job listing/description data, etc.). In such cases, the platform server 610 may accept inputs that correspond to readable text and/or natural language, both for the underlying source documents that correspond to the badge earner's skills (e.g., issued digital credential documents 900), for the underlying source documents that correspond to the badge earner's personality traits/interest data (e.g., issued personality badges, clinical assessments or evaluation results, etc.), and also for the underlying source documents that correspond to the skills/traits associated with particular occupations (e.g., occupation listing web documents 1000, job listings, job description data, etc.). Thus, the platform server 610 may transform each of these underlying natural language documents into vectors within a multi-dimensional vector space. During such a vector space analysis, the platform server 610 may preprocess and/or tokenize various data retrieved from the digital credentials in step 801. For example, the platform server 610 may implement a set of algorithms and/or other techniques to extract and parse particular data fields from the digital credential object(s) retrieved in step 801. For instance, referring again to the example digital credential view 900, the platform server 610 may extract various descriptive fields such as the credential title 901, description 902, skills 904, accomplishments/requirements 905, and/or technical standards 906. In various examples, any combination of the fields of digital credential templates and/or issued digital credentials may be extracted during preprocessing/tokenizing. Such preprocessing also may including extracting out individual keywords from certain text fields (e.g., the description 902, requirements 905, etc.), whereas other data fields may be maintained as lists of separate single-word or multi-word terms (e.g., skills 904, standards 906, endorsers 907, etc.). The preprocessing and/or tokenization also may include performing stemming processes, formatting processes, and/or processes for identifying synonyms or substitute related terms. Additionally, the platform server 610 may be configured to detect multi-word keywords within certain data fields 901-912, whereas single individual word keywords may be extracted and processed separately for other data fields 901-912. In some embodiments, a single user may have several different associated digital credentials, such as a credential receiver 640 that has earned multiple credentials/badges. If a particular user has multiple digital credentials, then each of the user's multiple credentials may be retrieved and processed, and the platform server 610 may determine that a single aggregated digital credential object may be created by aggregating certain selected data fields from the multiple different digital credentials associated with the user or entity. For instance, the platform server 610 may identify predetermined matching data fields (e.g., title 901, description 902, skills 904, etc.) in each of user's digital credentials, and may create a single aggregated digital credential object by aggregating the data within each of the predetermined matching data fields. However, in other embodiments, the platform server 610 might not determine that a single aggregated digital credential object should be created, and instead may perform the preprocessing and/or tokenization processes, and the subsequent vector space analysis, separately for each of the receiver's issued digital credentials.

When a vector space analysis is performed in step 809, after the preprocessing and/or tokenization processes, the resulting digital credential data may be transformed into one or more vector queries, and used as input to perform vector space analyses to select the most similar field data objects. Initially, each digital credential (or combination of digital credentials) may be transformed into a vector query that may be input into the same multi-dimensional vector space. In some embodiments, the platform server 610 may use an algorithm to build a vector query from the digital credential, by transforming one or more fields 901-912 from the digital credential into a predetermined format. In some cases, the vector query may include one or more text fields (e.g., corresponding to the title field, description field, etc.) and one or more delimited lists of keywords (e.g., corresponding to the skills field, requirements field, standards field, endorsements field, etc.). The digital credential platform server 610 then may initiate a vector space analysis in which generated the vector query (or queries) are compared to each of the vector objects corresponding to the fields/occupations identified in step 804, to determine which fields/occupations are most similar to the receiver's set of digital credentials. In some embodiments, the platform server 610 may initiate the execution of a vector space modeling engine and may pass the vector query to the modeling engine. The platform engine may execute the query within a same multi-dimensional vector space into which a plurality of field/occupation data objects (e.g., occupation listing web documents 1000) have been vectorized and imported. The execution of the vector query may include calculating the distance between the vector query and each of the field data objects within the multi-dimensional vector space. In some cases, the distance between the vector query and the a particular field data object within the multi-dimensional vector space may correspond to the angle between these two vectors (i.e., the query and the field data object). For instance, a smaller angle between the vectors within the multi-dimensional space may indicate a higher degree of similarity. In some cases, platform server 610 may calculate the angle between two vectors via a multi-step process including multiplying the corresponding components (pairwise) of the vectors and summing those values, normalizing by the product of the lengths of the two vectors, and then using that data to calculate the cosine of the angle between the vectors (i.e., cosine similarity). The platform server 610 may then select one or more of the field/occupation data objects based on the distances between the vectors calculated. The most similar field/occupation documents may be identified as those having the closest distance to the vector query. For instance, the algorithms of the platform server 610 may be configured to select the N closest field/occupation documents to the input vector query, or may be configured to select all of the field/occupation documents (regardless of the number returned) within a predefined vector closeness threshold (e.g., calculated cosine similarity >0.7, 0.8, 0.9, etc.). As noted above, the request for the most similar field/occupation data may be based on a combination of digital credentials corresponding to a particular receiver/badge earner, as well as the combination of personality trait/interested data associated with the receiver/badge earner. Thus, the selection of field/occupation data objects when a vector space analysis is used in step 809 may include calculating distances between each of multiple vector queries (one for each digital credential and/or each verified natural language personality trait/interest data) and each of the field/occupation documents identified in step 804, and then summing the distances for each field/occupation document to determine which field/occupation documents are closest to the combination of digital credentials and personality trait/interested data provided. Further, in some embodiments, the selection of the most similar field/occupation data objects need not be based solely on the calculated distances between the vectors, but also may include weightings the distances and/or additional factors including within the calculation. For instance, the field/occupation documents 1000 and their corresponding field data objects may be weighted based on factors such as field/occupation income, geography, the number of currently available job postings matching the field/occupation, etc. When the platform server 610 determines that one or more of these weighting factors is present for a particular field/occupation data object, it may apply one or more weighting multipliers that will result in a shorter distance calculation between the particular field/occupation data object and the vector query, thereby increasing the chance that that particular field/occupation data object will be selected as a most similar field/occupation.

In other embodiments, rather than performing a vector space analysis to determine the correlation score in step 809, as discussed above, various other techniques may be used to identify the fields/occupations that most closely match the skills, personality traits/interests, and the career stage of the credential receiver. For example, in some cases, the correlation score may be calculated using a mathematically-based statistical model, including models based on one or more of Item Response Theory (IRT), Bayesian Network (Bayes net), Logistic Regression, Discriminant Function Analysis, Principal Factor Analysis (PFA), linear and/or non-linear multiple regression models, multivariate base rate analysis, or the like. The determined correlation scores also may be based on neural networks and trained machine learning algorithms. For example, the platform server 610 may comprise neural network system including various components configured to generate and manage artificial neural network data structures used to perform decision-making and/or predictive analyses based on data received corresponding to the credential receiver and the corresponding data associated with the fields/occupations identified in step 804. Such neural network data structures may be designed, constructed, and trained by adaptive learning processes to analyze complex sets of inputs (e.g., issued badge/skills data, personality trait/interest data, career stage data and other factors, etc.) and provide predictive outputs corresponding to the overall suitability of the match between the badge earner and the occupations/fields (e.g., using predictions corresponding to work satisfaction, worker performance, etc.).

As noted above, in addition to the comparisons and analyses based on badges/skills data, personality trait/interest data, and career stage data, the calculation of the correlation scores in the 809 may take into account additional factors geographic regions (e.g., states, countries, etc.) of the badge earner and those of the field/occupation, various language abilities/requirements, minimum education levels/requirements, salary expectations/requirements, etc., between the badge earner data and field/occupation data. In some embodiments, the operation of the platform server 610 may be configurable to allow the analysis in step 809 to incorporate various filters for these different factors. For example, a career stage filter may be added/removed (e.g., via an API call or other user interface), to determine whether or not the platform server 610 will take into account the comparison of the career stage/phase in step 808 when calculating the overall correlation score in step 809. When such a career stage is turned off the correlation scores calculated in step 809 may be based on the comparisons of skills and personality traits/interests between the badge earner and the field/occupation, but not based on any matching or fit analysis of career stage. Similarly, geographic location filters, salary filters, current job listing filters, language filters, health-based filters, etc. may be optionally applied in various embodiments to further customize the results of the correlation score calculations in step 809. In some cases, such filters may cause the exclusion of certain results (e.g., highly correlated matching fields/occupations that would otherwise be selected for the credential receiver), while in other cases such filters may apply weight values to positively or negatively weight the correlation scores of certain results so that these results are not necessarily excluded but may be more or less likely to be selected for the credential receiver.

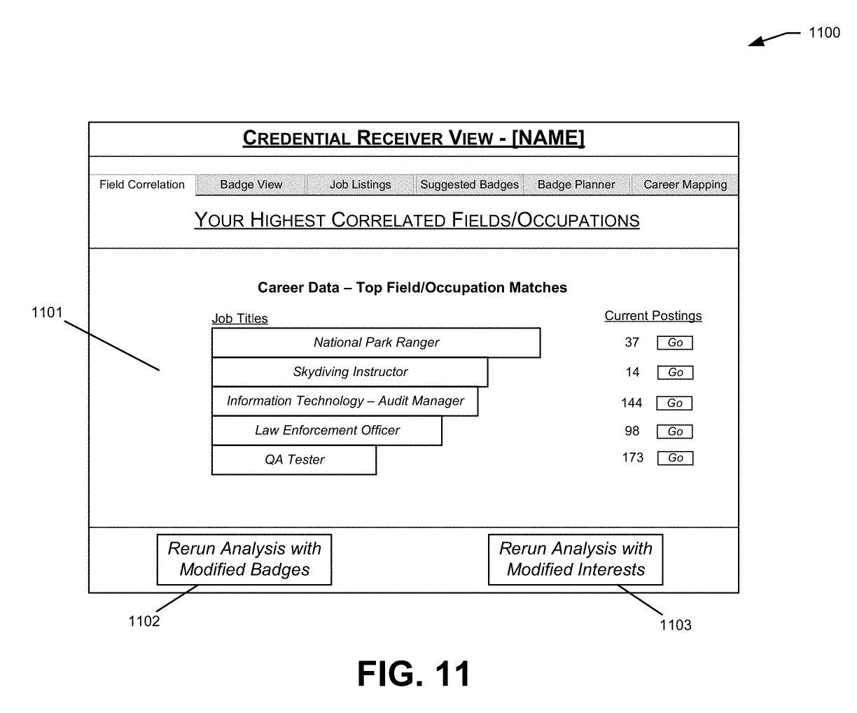

In step 810, the overall correlations scores for each field data object identified in step 803 may be ranked and the fields/occupations that correlate most closely to the badge earner's skills/abilities, interests/personality, career stage and/or other characteristics, may be selected and output in response to the initial request. For example, referring now to FIG. 11, an example user interface screen 1100 (e.g., a web page or application display screen) is shown representing a credential receiver view that illustrates various features that may be available to authorized badge earners via the platform server 610. After logging-in to the badge earner user interface 1100, the badge earner may be provided several possible data screens and features related to the user's badge portfolio. As shown in this example, the user may view their field correlation results 1101 (e.g., via the “Field Correlation” tab), which may include an updated listing of the most highly correlated fields/occupations for the digital credential receiver, based on the calculation of the receiver's highest overall correlation scores to different field data objects in step 810. In this cases, the four occupations most closely correlated to the badge earner are shown by job title, including a link to recent job posting for each of the occupations. In some embodiments, some or all of steps 801-810 may be performed each time a user logs in and accesses their credential receiver view, so that the results may update automatically in response to any updates to the receiver's credentials, the receiver's personality/skills/interest data or any other data, and/or based on any changes to the underlying data within the field data stores/indexes 725 and 730.

In this example, additional user options are show to rerun the analysis with modified badges 1102, and to rerun the analysis with modified user interests 1103. These options may be supported by the platform server 610 in some cases, to allow the credential receiver to view and make hypothetical changes to their own digital credentials (1102) and/or to their own skills/interests, and then to run a field correlation analysis to retrieve a set of matching/correlated fields/occupations for the hypothetical profile. As noted above, it may be advantageous for the platform server 610 to enforce both security and full verification of the issued credentials and evaluation results data for credential receivers, so that any unauthorized modification is prevented (even by the credential receiver himself/herself), to prevent fraud or manipulation of correlation analysis processes. Thus, when options 1102 or 1103 are selected in this example, the platform server 610 may create a mirror profile for the credential receiver (e.g., including the receiver's issued badges, interest data, and any other data described herein), allowing the receiver to modify their mirror profile and then rerun the analyses to view different correlations of their mirrored profile to fields/occupations that take into account hypothetical changes (e.g., different personality traits, career stage, badges, etc.), without affecting the receiver's actual underlying profile within the data stores 710 and 715. Using similar techniques, in some cases, the platform server 610 in may automatically perform a matching/correlation process for fields/occupations for one or more modified profiles of a credential receiver, in order to make recommendations to the credential receiver of particular skills (e.g., badges) that the receiver may acquire, and/or certain personality traits/interests that the receiver may cultivate or diminish, in order for the credential receiver to correlate/match more closely to certain occupations/fields. As noted above, in other embodiments, credential receivers might be prevented even from viewing their own personality/interest data, and/or certain of their own issued badge data from data stores 710 and 715, in order to prevent attempts by users to update their evaluations, create new accounts/profiles, or to otherwise manipulate the correlation analysis processes.

Although FIG. 8 illustrates an embodiment in which the platform server 610 is used to retrieve a set of fields/occupations that most closely match or fit a the input data of a digital credential receiver, including skills data, personality trait/interest data, career stage data, etc., other related embodiments may be implemented in which the platform server 610 receives (e.g., via an API) an input set of one or more fields/occupations (e.g., occupation listing web documents, other job listings or descriptions and/or job data such as job-specific desirable personality traits/interests, salary data, location data, career stage data, etc.). Thus, in such embodiments, all steps described above in FIG. 8 may be reversed with respect to the digital credential receivers and the corresponding field/occupation documents or listings. From the perspective of a client device 620-660 in these cases, the client may provide one or more fields/occupations (e.g., one or more documents 1000 and/or other field/occupation/job identifiers), and the platform server 610 may use similar techniques (e.g., vector space models, regression analysis, trained neural networks and machine learning etc.) to provide a set of credential receivers back to the client device that represent the most closely matching or fitting job candidates to the fields/occupations/jobs provided as input. Additionally, in some embodiments, feedback mechanisms may be implemented to revise and improve the processes described above for determining and retrieving the most closely matching fields/occupations for a particular credential receiver and vice versa.

As described above, certain aspects of the disclosure relate to credential receiver data which may include the results of personality tests, interests surveys, psychological evaluations, and the like. As noted above, these results may be received from secure third-party data sources 735 for particular receivers, and stored in a credential receiver data store 710. However, in some embodiments, badges/credentials may be earned by and issued to users based on the detection of specific personality characteristics, interests, and traits, as well as for combinations of such characteristics, traits, etc. Thus, in such cases, the personality/interest data for credential receivers may be stored as issued badges in a credential object data store 715, rather than in data stores 710 storing other credential receiver data.

As discussed above, in order to determine personality traits and award badges, credentialing systems may analyze the credential receiver's existing data (e.g., social graph, profile, language used in emails, etc.). In other embodiments, specific personality tests may be administered (e.g., using a written testing environment, simulation lab or other physical environment, and/or on-the-job monitoring processes). For example, receivers may take a test/simulation within a specially-designed virtual reality or augmented reality simulation environment, in order to identify specific personality traits. Such personality traits may include, for example, self-consciousness, curiosity, modesty, achievement-oriented, optimistic, etc., each of which may be tested separately and quantified based on the user's test scores/simulation performance. In various embodiments, potential uses may include optimal team-building by employers, by matching and complementing personality traits of different team members with each other and with supervisors.

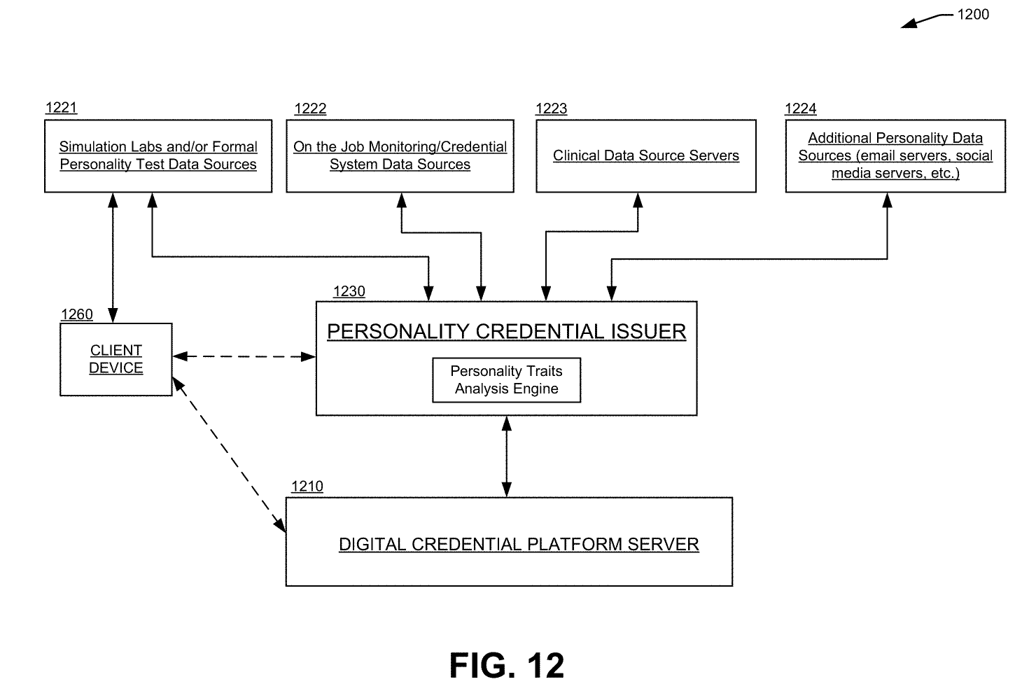

Referring now to FIG. 12, an example computing environment 1200 is shown, including a digital credential platform server 1210, in communication with a personality badge issuer 1230. In some examples, the digital credential platform server 1210 may be a badging server similar or identical to the platform server 610 discussed above. Thus, server 1210 may be configured as a badge repository and credentialing system, acting as a clearinghouse for badge owners, issuers, earners, endorsers, etc. Server 1210 may include a digital credential (or badge) data store configured to store badging information such as the details of the particular badges earned by particular users. As noted above, such details may identify the badge issuer and/or other testing/credential authorities responsible for administering testing or simulation scenarios as part of the badging process, and/or for pre-badge or post-badge monitoring of workstations/workplaces to detect and analyze user tasks performance and user skills/abilities.

In this example, the platform server 1210 may be configured to support personality-based credentials using the same or similar infrastructure as certification-based credentials, skills-based credentials, and professional credentials, etc. Thus, one or more personality credential issuers 1230, along with personality credential owners which may be the same as issuers 1230 or may be separate entities, may be configured to determine eligibility for personality credentials and to issue personality credentials. In some cases, a user may interact directly with a personality credential owner and/or credential issuer 1230, via a client device 1260, to request (or apply for) a particular personality credential. In other cases, the process of issuing a personality-based credential to a user may be initiated by a different entity, such as an authorized individual at the user's school (e.g., a teacher or counselor), a medical professional (e.g., the user's doctor or therapist, etc.), or the user's employer, etc. In various embodiments, personality-based credentials may be “earned” by users that qualify for the credential, based on the results of personality tests and/or analysis of other personality data. Examples of potential types of personality-based credentials that may be supported by the system 1200 include, for instance, conscientiousness, curiosity, modesty, achievement-oriented, optimism, integrity, honesty, loyalty, responsibility, humility, compassion, fairness, courageousness, self-awareness, generosity, perseverance, politeness, kindness, lovingness, reliability, and self-disciplined, among others. Further, for each different personality trait, credentials may be earned for the personality trait or its opposite (e.g., honesty or deceitfulness, etc.), for any combination of traits, and credentials also may be earned for different levels of these personality traits (e.g., classified into low/medium/high levels, or quantified onto a scale 1-10 or 1-100, or as a percentile of the general population, etc.).

As shown in this example, in order to determine when a user is eligible for or has earned a personality-based credential, the credential issuer 1230 may receive personality-related data for a user from a variety of data sources, including a formal testing data sources 1221, on-the-job monitoring and/or credentialing systems 1222, external clinical data sources 1223, and other external data sources 1224 that may store personality-related information. Formal testing data sources 1221 may include, for instance, educational facilities, testing centers and/or secure websites configured to administer personality tests to users. In some embodiments, formal testing location 1221 may include a simulation lab physical environment with live and/or simulated tests (e.g., virtual reality, augmented reality, etc.) designed to measure particular personality traits of the user. In some cases, a user may interact directly with a formal testing data source 1221 via a client device 1260. On-the-job monitoring and/or credentialing systems 1222 may include similar or identical systems to those described above, which may monitor and evaluate the user's actions while working, studying, and/or during normal daily interactions. External clinical data sources 1223 may include doctor's offices, therapists, etc., which may provide (when authorized, and transmitted securely) previous clinical diagnoses of the user. Finally, the additional data sources 1224 may include any other data source with relevant personality-related data may be retrieved and analyzed to identify personality traits of the user with a sufficiently high degree of confidence. For instance, additional data sources 1224 may include email servers and documents stores from which the user's documents and emails may be retrieved and analyzed to determined communication styles and personality traits. Data sources 1224 also may include financial servers (e.g., to obtain the user's bank statements), educational record servers (e.g., to obtain the user's grades, transcripts, disciplinary issues), governmental servers (e.g., to obtain the user's criminal record, etc.), all of which may be analyzed in conjunction with the other data sources 1221-1224 to identify personality traits of the user.

Personality-based credentials issued by the issuer 1230 may be stored within the credential platform server 1210, where they may be stored with and/or associated with the particular user and the user's portfolio of other credentials. The server 1210 also may be configured to track the valid time and/or expiration date of personality-based credentials, which may be performed different than skills-based credentials and the like. For instance, in some embodiments, an education-based credential for the completion of a class, or a skills-based credential for demonstration of the skill may be assigned expiration dates after which the user may be required to retest or recertify to prove that the user's knowledge or skill is current. In contrast, while certain personality-based credentials might expire in a similar manner after a time threshold, other types of personality-based credentials may be maintained indefinitely until some affirmatively proofs that the personality-based credential is no longer applicable to the user. For instance, a user who has “earned” a negative personality-based credential cannot simply wait for the negative credential to expire, but may have to affirmatively retest to prove that the negative credential should be removed. Finally, platform server 2010 may be configured to receive and process requests from different entities for a user's personality-based credentials, and thus may authenticate such requests to protect the security and confidentiality of personality-based credentials.

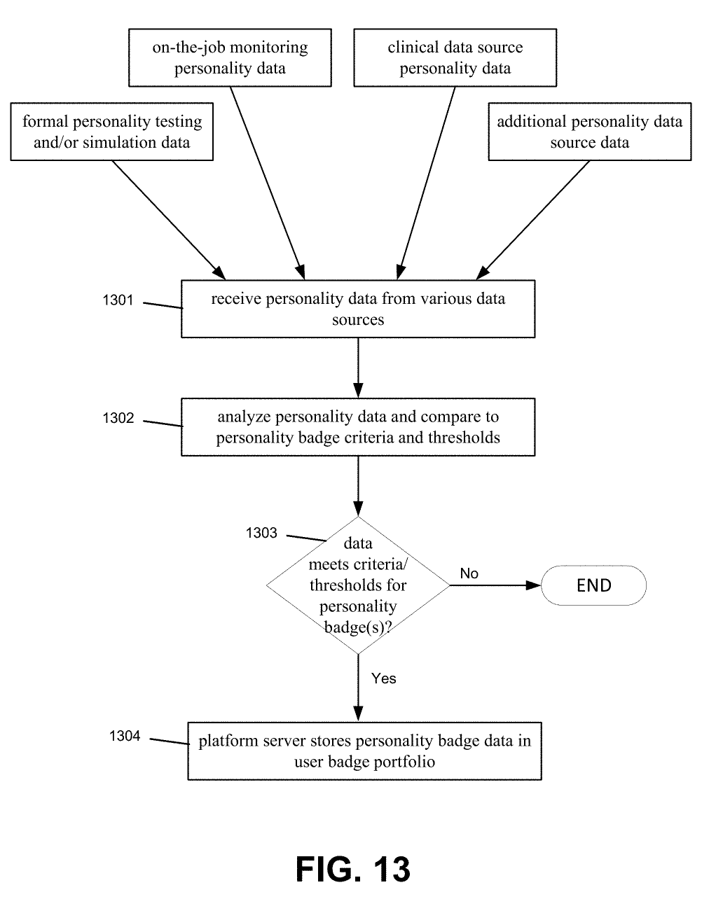

Referring now to FIG. 13, an example flow diagram is shown illustrating an example process by which a credential issuer 1230 may receive personality data relating to a user and may issue personality-based based to the user. In step 1301, in response to a request from a particular user or a related entity (e.g., teacher, employer, doctor, etc.), a credential issuer system 1230 may retrieve personality data from one or more available data sources 1221-1224. As noted above, the personality-related data retrieved in step 1301 may include clinical assessments of the user transmitted securely from a doctor, counselor, therapist, etc., as well as formal personality test document, personality simulation (e.g., live, VR, or AR), on-the-job or live user tracking and monitoring data, and/or data from other data sources such as the user's emails, documents, social media and/or web activities, etc. In step 1302, the credential issuer may analyze the received personality and evaluate the user with respect to a plurality of different personality traits and/or combination of traits to determine if the user is eligible for one or more personality-based credentials. In various embodiments, step 1302 may include a variety of algorithms to analyze and score personality data, and comparisons of the personality scores to different thresholds. In step 1303, if the user's personality data meets the criteria for one or more personality-related credentials (1303:Yes), then in step 1304 the credential issuer may issue the credentials to the user and (upon acceptance from the user) transmit the credential data to the platform server 1210 for storage in the user's credential portfolio.

As noted above, in some embodiments, the platform server 610 may support certification, verification, and security of credentials issued by different credentials issuers to different credential receivers In order to address the problem of credentials from anonymous/unverified badge owners and issuers, a central certification platform or service may be created to register credentials, and to analyze and verify skills associated with different credentials. Thus, an unknown and anonymous credential issuer could not simply issue new credentials claiming to be a quality and verified certification of skills A, B, C. Rather, the certification platform/service may verify non-subjectively that credentials correspond to the skills that they purport to verify.

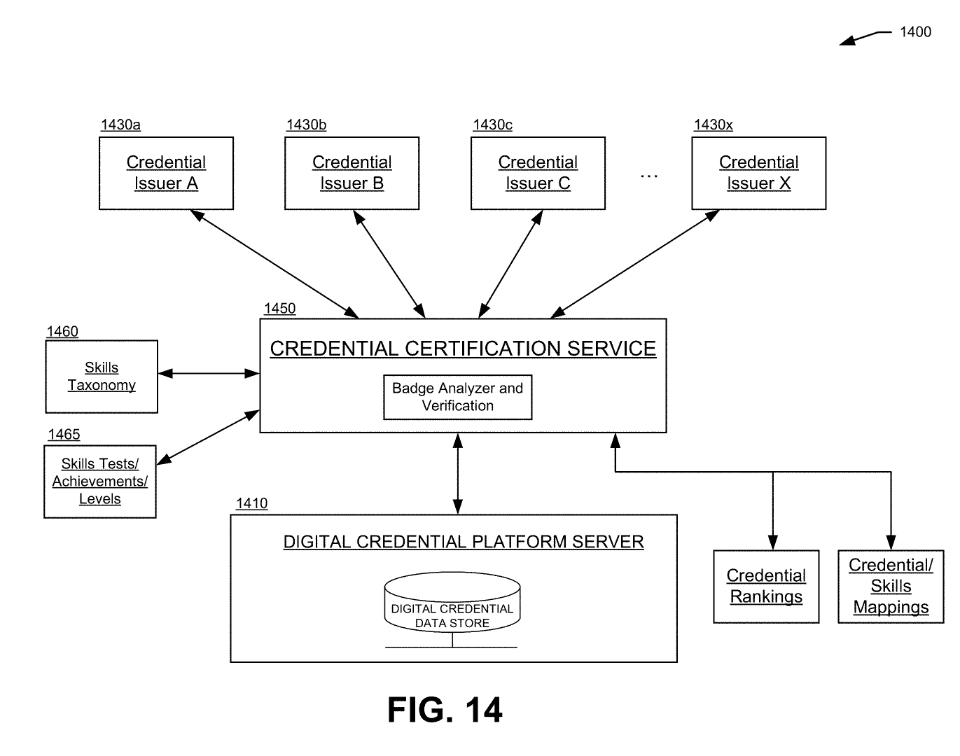

For example, referring now to FIG. 14, an illustrative computing environment is shown including a digital credential platform server 1410, a credential certification service 1450, and multiple credential issuers 1430a-x. In this example, the credential certification service 1450 may receive and analyze credential-related data, such as the credential qualifications, from each credential issuer 1430, in order to certify the credential before allowing each credential to be stored in the platform server 1410. In some cases, the credential certification service 1450 may use a universal taxonomy of skills 1460 and corresponding skills tests, achievements, and levels 1465, in order to evaluate the qualifications of each credential. These credential qualifications may be mapped to different nodes of the skills taxonomy 1460, and may be compared to the baseline tests, achievements, and levels for that skill in database 1465. Thus, database 1460 and/or 1465 may include an objective set of testable skills or other metrics that may be used to evaluate credentials, rather than just trusting the credential issuer 1430 that a particular credential is a good indicator of the skills listed within the credential.

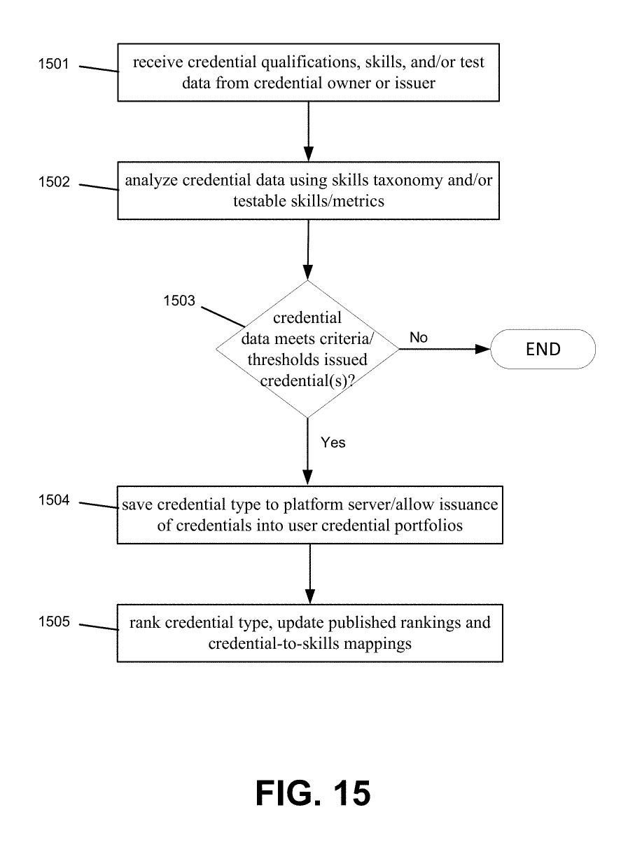

Referring now to FIG. 15, a flow diagram is shown illustrating a process for certifying and registering credentials within a credentialing platform, and verifying the associated skills of a credential. In step 1501, the credential certification service 1450 may receive new credential type data from a credential issuer. The credential type data may include the description and skills of the new credential type that the credential issuer 1430 plans to be begin issuing to users. In some embodiments, the credential type data may include the specific qualifications and tests that will be required for users to obtain the credential, include written tests, simulation descriptions and/or software, on-the-job monitoring software and criteria, and any other qualifications of the new credential. In step 1502, the credential certification service 1450 may analyze the new credential type data, description, purported skills, qualifications, etc., in order to determine whether or not the credential type will be supported by the platform server 1410. In some cases, the service 1450 may use software, one or more artificial intelligence (AI) systems, and/or human testing of the credentialing qualifications and/or processes of a new credential from a credential issuer 1430, so that credential issuers cannot list skills associated with a new credential type unless each of those skills has been verified. Additionally, in some cases, the analysis in step 1502 may depend on endorsement data, user feedback data, and/or statistical data associated with credential earners (e.g., hiring rates for credential earners, income change based on credential earning, etc.). In step 1503, if credential certification service 1450 determines that the credential qualifications/processes from the credential issuer to not meet minimum basic skills thresholds for the purported skills (1503:No), then the service 1450 may not permit the new credential type from the issuer 1430. However, if the analysis of the credential qualifications and processes determines that the new credential type does meet the necessary skills thresholds for the purported skills (1503:Yes), then the service 1450 may import the new credential type into the platform server 1410, and allow new credential of the type to be issued to users in step 1504. Additionally, data from these analyses in step 1502-1503 also may be used to produce a mapping of credentials to skills (and vice versa), credential issuers to skills (and vice versa), and to rank the quality of credentials, credential owners, and credential issuers. Thus, in step 1505, based on the analysis of the credential processes and qualifications, the credential certification service 1450 may add the newly certified/registered credential to published lists of credential ranking and credential-to-skill mappings, that may be searchable to potential credential earners and others interested in verifying the legitimacy and qualify of particular credentials.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

What is claimed is:

1. A digital credential platform server configured to map digital credential receivers to field data objects, the digital credential platform server comprising:
a processing unit comprising one or more processors;
one or more network interfaces; and
memory coupled with and readable by the processing unit and storing therein a set of instructions which, when executed by the processing unit, causes the digital credential platform server to:
receive a request from a first client device for a set of field data objects associated with a digital credential receiver;
in response to the request, retrieve data associated with the digital credential receiver, said data comprising:
(a) data identifying one or more digital credential objects received by the digital credential receiver;
(b) one or more verified evaluation records of the digital credential receiver; and
(c) data identifying a current career phase of the digital credential receiver;
access and analyze a plurality of field data objects stored in a data structure;
select a first subset of the plurality of field data objects correlating to the digital credential receiver, wherein the first subset of field data objects is selected based on a correlation analysis between the data associated with the digital credential receiver and a plurality of characteristics of the plurality of field data objects;
for each particular field data object of the selected first subset of field data objects, calculate a correlation score for the particular field data object, wherein the correlation score for the particular field data object is based on:
(a) a first comparison of the digital credential objects received by the digital credential receiver to first capability characteristics of the particular field data object;
(b) a second comparison of the evaluation records of the digital credential receiver to second interest characteristics of the particular field data object; and
(c) a third comparison of the current career phase of the digital credential receiver a third career phase characteristic of the particular field data object; and
transmit data identifying the correlation score for each of the selected first subset of field data objects, to the first client device in response to the request.

2. The digital credential platform server of claim 1, wherein performing the correlation analysis between the data associated with the digital credential receiver and the plurality of characteristics of the field data objects comprises:
determining a set of capabilities of the digital credential receiver, based on the digital credential objects received by the digital credential receiver;
determining an initial matching set of field data objects having capability characteristics matching the determined set of capabilities of the digital credential receiver;
retrieving a set of interest characteristics associated with each of the initial matching set of field data objects, and
comparing, for each of the initial matching set of field data objects, the retrieved interest characteristics associated with the field data object to interest characteristics identified within the evaluation records of the digital credential receiver.

3. The digital credential platform server of claim 1, wherein retrieving the verified evaluation records of the digital credential receiver comprises requesting and receiving said verified evaluation records from a secure third-party server, and wherein the verified evaluation records are not received from a client device operated by the digital credential receiver.

4. The digital credential platform server of claim 3, wherein the digital credential platform server prohibits the digital credential receiver from accessing the verified evaluation records received from the secure third-party server.

5. The digital credential platform server of claim 3, the memory storing therein additional instructions which, when executed by the processing unit, causes the digital credential platform server to:
receive a request from a client device operated by the digital credential receiver for the verified evaluation records received from the secure third-party server;
provide the verified evaluation records received from the secure third-party server, to the client device operated by the digital credential receiver;
receive, from the client device operated by the digital credential receiver, a modification to the verified evaluation records; and
update the selection of the first subset of field data objects correlating to the digital credential receiver, based on the modification to the verified evaluation records received from the digital credential receiver.

6. The digital credential platform server of claim 1, the memory storing therein additional instructions which, when executed by the processing unit, causes the digital credential platform server to:
determine one or more expiration dates associated with the verified evaluation records received from the secure third-party server;
compare the one or more expiration dates to a time associated with the request from the first client device; and
perform the selection of the first subset of the data field objects, and the calculation of the correlation score for each of the first subset of data field objects, in response to determining that the verified evaluation records associated with the digital credential receiver are not expired.

7. The digital credential platform server of claim 1, wherein the verified evaluation records of the digital credential receiver comprise one or more of: results of a personality or interest evaluation administered by a medical professional, or an automated evaluation of digital records of interpersonal interactions of the digital credential receiver.

8. The digital credential platform server of claim 1, wherein the data identifying the current career phase of the digital credential receiver comprises one or more of: a seniority level of the digital credential receiver, or an age of the digital credential receiver.

9. A method of mapping digital credential receivers, comprising:
receiving, by the digital credential platform server, a request from a first client device for a set of field data objects associated with a digital credential receiver;
in response to the request, retrieving, by the digital credential platform server, data associated with the digital credential receiver, said data comprising:
(a) data identifying one or more digital credential objects received by the digital credential receiver;
(b) one or more verified evaluation records of the digital credential receiver; and
(c) data identifying a current career phase of the digital credential receiver;
accessing and analyzing, by the digital credential platform server, a plurality of field data objects stored in a data structure;
selecting, by the digital credential platform server, a first subset of the plurality of field data objects correlating to the digital credential receiver, wherein the first subset of field data objects is selected based on a correlation analysis between the data associated with the digital credential receiver and a plurality of characteristics of the plurality of field data objects;
for each particular field data object of the selected first subset of field data objects, calculating a correlation score for the particular field data object, by the digital credential platform server, wherein the correlation score for the particular field data object is based on:
(a) a first comparison of the digital credential objects received by the digital credential receiver to first capability characteristics of the particular field data object;
(b) a second comparison of the evaluation records of the digital credential receiver to second interest characteristics of the particular field data object; and
(c) a third comparison of the current career phase of the digital credential receiver a third career phase characteristic of the particular field data object; and
transmitting, by the digital credential platform server, data identifying the correlation score for each of the selected first subset of field data objects, to the first client device in response to the request.

10. The method of mapping digital credential receivers of claim 9, wherein performing the correlation analysis between the data associated with the digital credential receiver and the plurality of characteristics of the field data objects comprises:
determining a set of capabilities of the digital credential receiver, based on the digital credential objects received by the digital credential receiver;
determining an initial matching set of field data objects having capability characteristics matching the determined set of capabilities of the digital credential receiver;
retrieving a set of interest characteristics associated with each of the initial matching set of field data objects, and
comparing, for each of the initial matching set of field data objects, the retrieved interest characteristics associated with the field data object to interest characteristics identified within the evaluation records of the digital credential receiver.

11. The method of mapping digital credential receivers of claim 9, wherein retrieving the verified evaluation records of the digital credential receiver comprises requesting and receiving said verified evaluation records from a secure third-party server, and wherein the verified evaluation records are not received from a client device operated by the digital credential receiver.

12. The method of mapping digital credential receivers of claim 11, wherein the digital credential platform server prohibits the digital credential receiver from accessing the verified evaluation records received from the secure third-party server.

13. The method of mapping digital credential receivers of claim 11, further comprising:
receiving a request from a client device operated by the digital credential receiver for the verified evaluation records received from the secure third-party server;
providing the verified evaluation records received from the secure third-party server, to the client device operated by the digital credential receiver;
receiving, from the client device operated by the digital credential receiver, a modification to the verified evaluation records; and
updating the selection, by the digital credential platform server, of the first subset of field data objects correlating to the digital credential receiver, based on the modification to the verified evaluation records received from the digital credential receiver.

14. The method of mapping digital credentials of claim 9, further comprising:
determining one or more expiration dates associated with the verified evaluation records received from the secure third-party server;
comparing the one or more expiration dates to a time associated with the request from the first client device; and
performing the selection of the first subset of the data field objects, and the calculation of the correlation score for each of the first subset of data field objects, in response to determining that the verified evaluation records associated with the digital credential receiver are not expired.

15. The method of mapping digital credential receivers of claim 9, wherein the verified evaluation records of the digital credential receiver comprise one or more of: results of a personality or interest evaluation administered by a medical professional, or an automated evaluation of digital records of interpersonal interactions of the digital credential receiver.

16. The method of mapping digital credential receivers of claim 9, wherein the data identifying the current career phase of the digital credential receiver comprises one or more of: a seniority level of the digital credential receiver, or an age of the digital credential receiver.

17. A non-transitory computer-readable medium, having instructions stored therein, which when executed by a computing device cause the computing device to perform a set of operations comprising:
receiving a request from a first client device for a set of field data objects associated with a digital credential receiver;
in response to the request, retrieving data associated with the digital credential receiver, said data comprising:
(a) data identifying one or more digital credential objects received by the digital credential receiver;
(b) one or more verified evaluation records of the digital credential receiver; and
(c) data identifying a current career phase of the digital credential receiver;
accessing and analyzing a plurality of field data objects stored in a data structure;
selecting a first subset of the plurality of field data objects correlating to the digital credential receiver, wherein the first subset of field data objects is selected based on a correlation analysis between the data associated with the digital credential receiver and a plurality of characteristics of the plurality of field data objects;
for each particular field data object of the selected first subset of field data objects, calculating a correlation score for the particular field data object, wherein the correlation score for the particular field data object is based on:
(a) a first comparison of the digital credential objects received by the digital credential receiver to first capability characteristics of the particular field data object;
(b) a second comparison of the evaluation records of the digital credential receiver to second interest characteristics of the particular field data object; and
(c) a third comparison of the current career phase of the digital credential receiver a third career phase characteristic of the particular field data object; and
transmitting data identifying the correlation score for each of the selected first subset of field data objects, to the first client device in response to the request.

18. The non-transitory computer-readable medium of claim 17, wherein
performing the correlation analysis between the data associated with the digital credential receiver and the plurality of characteristics of the field data objects comprises:
determining a set of capabilities of the digital credential receiver, based on the digital credential objects received by the digital credential receiver;
determining an initial matching set of field data objects having capability characteristics matching the determined set of capabilities of the digital credential receiver;
retrieving a set of interest characteristics associated with each of the initial matching set of field data objects, and
comparing, for each of the initial matching set of field data objects, the retrieved interest characteristics associated with the field data object to interest characteristics identified within the evaluation records of the digital credential receiver.

19. The non-transitory computer-readable medium of claim 17, wherein
retrieving the verified evaluation records of the digital credential receiver comprises requesting and receiving said verified evaluation records from a secure third-party server, and wherein the verified evaluation records are not received from a client device operated by the digital credential receiver.

20. The non-transitory computer-readable medium of claim 17, the instructions causing the computing device to perform further operations comprising:
determining one or more expiration dates associated with the verified evaluation records received from the secure third-party server;
comparing the one or more expiration dates to a time associated with the request from the first client device; and
performing the selection of the first subset of the data field objects, and the calculation of the correlation score for each of the first subset of data field objects, in response to determining that the verified evaluation records associated with the digital credential receiver are not expired.
